(19) United States
(12) Patent Application Publication
(10) Pub. No.: US 2025/0239760 A1
(43) Pub. Date: Jul. 24, 2025

(54) ANTENNA SUBSTRATE AND ANTENNA MODULE

(71) Applicant: Murata Manufacturing Co., Ltd., Nagaokakyo-shi (JP)

(72) Inventors: Masahiro IZAWA, Nagaokakyo-shi (JP); Kaneo NOMIYAMA, Nagaokakyo-shi (JP)

(73) Assignee: Murata Manufacturing Co., Ltd., Nagaokakyo-shi (JP)

(21) Appl. No.: 19/175,230

(22) Filed: Apr. 10, 2025

Related U.S. Application Data
(63) Continuation of application No. PCT/JP2023/038868, filed on Oct. 27, 2023.

(30) Foreign Application Priority Data
Dec. 26, 2022 (JP) 2022-208321

(51) Int. Cl. H01Q 1/52; H01Q 1/48; H01Q 9/04; H01Q 9/30

(52) U.S. Cl. CPC H01Q 1/521; H01Q 1/48; H01Q 9/0407; H01Q 9/30

(57) ABSTRACT

An antenna substrate includes a baseplate, a first radiation electrode, a second radiation electrode disposed on the baseplate spatially apart from the first radiation electrode in a second direction (X), and a ground portion that is disposed on the baseplate and that is common to the first and the second radiation electrode. The ground portion includes a ground electrode that faces the first radiation electrode when seen from the first direction (Z), a connection line between the first radiation electrode and the second radiation electrode when seen from the first direction and that has a size that is smaller than a size of the ground electrode in a third direction (Y) orthogonal to the second direction when seen from the first direction (Z), and a stub.

### CROSS-REFERENCE TO RELATED APPLICATIONS

The present application is a bypass continuation application of international application No. PCT/JP2023/038868, filed Oct. 27, 2023, and claims priority to Japanese application 2022-208321, filed Dec. 26, 2022, the entire contents of each of which being incorporated herein by reference.

### TECHNICAL FIELD

The disclosure relates to an antenna substrate and an antenna module.

### BACKGROUND ART

Patent Document 1 discloses adjustment of the characteristics of a ground plane for optimizing the performance of an antenna system. FIG. 2 in Patent Document 1 shows an example of an antenna system. A system 200 in FIG. 2 includes a ground plane 201, antenna elements 202 and 203, a filter 204, and signals 205 and 206. The filter is provided by forming eight slots 204a in the ground plane.

Although the eight slots are orthogonal to linear paths between the antenna elements, the eight slots have lengths that do not allow them to traverse the entire ground plane. Therefore, a conductive path 204b that connects the antenna elements is formed in the ground plane. The slots each have a width that is sufficiently narrow and two sides of each slot in a width direction are coupled in a capacitive manner, as a result of which a capacitive reactance component is produced. On the other hand, an inductive reactance is produced in the conductive path. The filter is an LC filter that is based on the capacitive reactance component and the inductive reactance component.

### CITATION LIST

### Patent Document

Patent Document 1: U.S. Patent Application Publication No. 2008/94302

### SUMMARY

### Technical Problems

In Patent Document 1, as one non-limiting example of a technical problem, a filter reduces signals and contributes to improving isolation characteristics between the antenna elements. In Patent Document 1, in order to cause the slots to function effectively, it is necessary to ensure that the slots are sufficiently long in accordance with a frequency band of the signals to be reduced. In addition, the ground plane itself is required to be large so as to allow sufficiently long slots to be formed, as a result of which the size of the entire antenna system is increased.

In contrast, the present disclosure provides an antenna substrate and an antenna module, which can be reduced in size while making it possible to improve isolation characteristics between a first radiation electrode and a second radiation electrode.

### Solutions to Problems

As a non-limiting example, an antenna substrate according to an aspect of the disclosure includes a baseplate; a first radiation electrode that is disposed on the baseplate and that has a planar shape; a second radiation electrode that is disposed on the baseplate and spatially apart from the first radiation electrode in a second direction when seen from a first direction along a thickness direction of the baseplate; and a ground portion that is disposed on the baseplate and that is common to the first radiation electrode and the second radiation electrode, in which the ground portion includes a ground electrode that faces the first radiation electrode when seen from the first direction, a connection line between the first radiation electrode and the second radiation electrode when seen from the first direction and that has a size that is smaller than a size of the ground electrode in a third direction orthogonal to the second direction when seen from the first direction, and a stub that is connected to one of a first side and a second side of the connection line that face each other in the third direction.

An antenna module according to an aspect of the disclosure includes the antenna substrate and an electronic component that is mounted on the antenna substrate.

### Advantageous Effects of Disclosure

According to these and other aspects of the disclosure, it is possible to realize size reduction while making it possible to improve isolation characteristics between the first radiation electrode and the second radiation electrode.

### BRIEF DESCRIPTION OF DRAWINGS

FIG. 1 is a perspective view of an example of a structure of an antenna module according to a first embodiment.

FIG. 2 is a plan view of an antenna substrate that the antenna module in FIG. 1 includes.

FIG. 3 is a bottom view of the antenna substrate that the antenna module in FIG. 1 includes.

FIG. 4 is a bottom view of an example of a structure of an antenna substrate according to a second embodiment.

FIG. 5 is a bottom view of an example of a structure of an antenna substrate according to a third embodiment.

FIG. 6 is a bottom view of an example of a structure of an antenna substrate according to a fourth embodiment.

FIG. 7 is a bottom view of an example of a structure of an antenna substrate according to a fifth embodiment.

FIG. 8 is a perspective view of an example of a structure of an antenna substrate according to a sixth embodiment.

FIG. 9 is a plan view of the antenna substrate in FIG. 8.

FIG. 10 is a bottom view of the antenna substrate in FIG. 8.

FIG. 11 is a perspective view of an example of a structure of an antenna substrate according to a seventh embodiment.

FIG. 12 is a plan view of the antenna substrate in FIG. 11.

FIG. 13 is a bottom view of the antenna substrate in FIG. 11.

### DESCRIPTION OF EMBODIMENTS

### 1. Embodiments

Embodiments of the disclosure are described below with reference to the drawings in some cases. However, the embodiments below are exemplifications for describing the disclosure, and are not intended to limit the disclosure to the contents below (for example, the shape, dimensions, and arrangement of each structural element). Positional relationships, such as top, bottom, left, and right, are based on positional relationships shown in the drawings unless otherwise particularly indicated. Each figure that is described in the embodiments below is a schematic view, and the ratios of the size and the thickness of the structural elements in each figure do not necessarily reflect the actual dimensional ratios. In addition, the dimensional ratios of the elements are not limited to the ratios illustrated in the drawings.

Note that, in the description below, when it is necessary to distinguish between a plurality of structural elements, a prefix, such as “first” or “second”, is added to the names of the structural elements. However, when it is possible to distinguish between these structural elements by reference signs that are added to these structural elements, a prefix, such as “first” or “second”, may be omitted from the viewpoint of making it easier to read the sentences.

### 1.1 First Embodiment

### 1.1.1 Structure

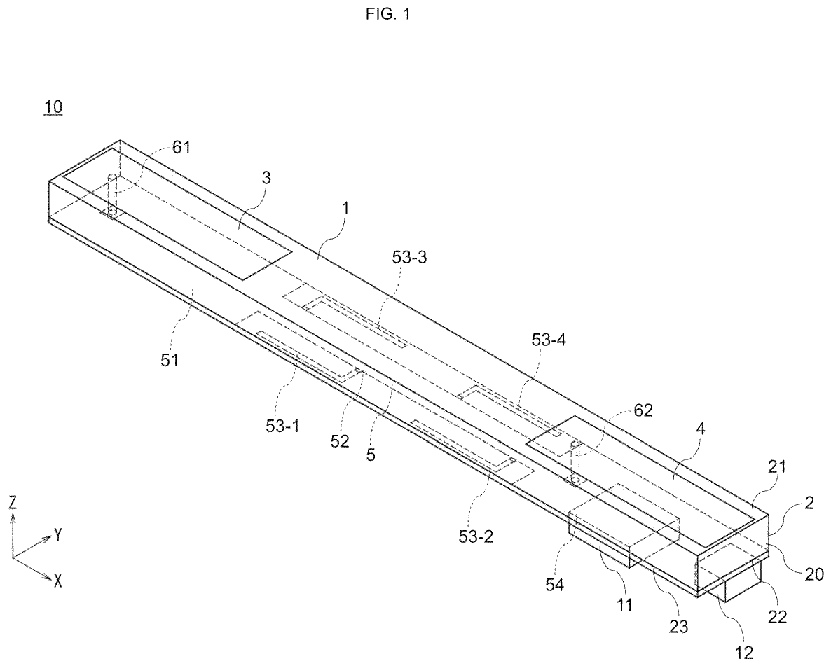

FIG. 1 is a perspective view of an example of a structure of an antenna module 10 according to a first embodiment. The antenna module 10 is mounted on, for example, a device for radio communications in a predetermined frequency band. The antenna module 10 includes an antenna substrate 1 and electronic components 11 and 12 that are mounted on the antenna substrate 1. FIG. 1 schematically shows the electronic components 11 and 12.

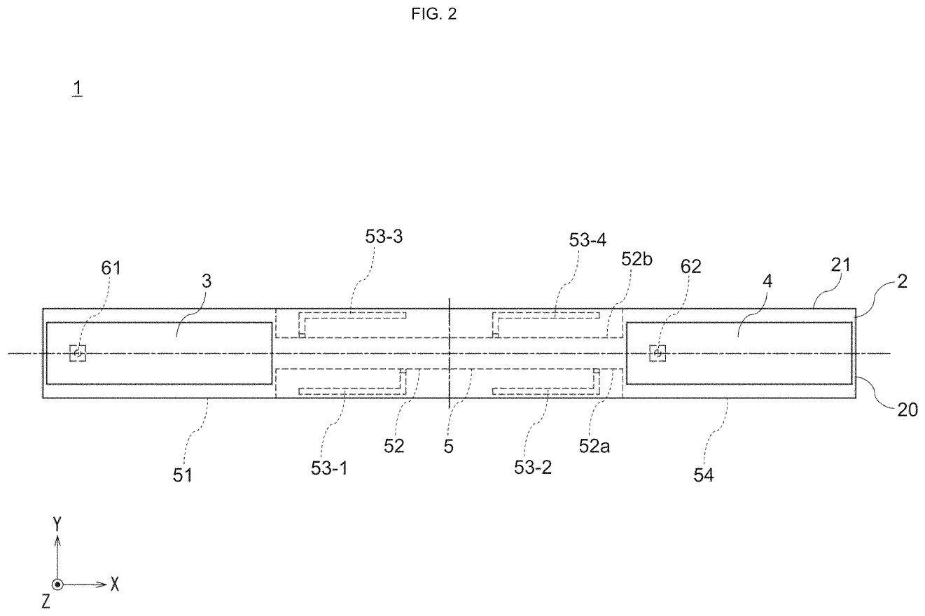

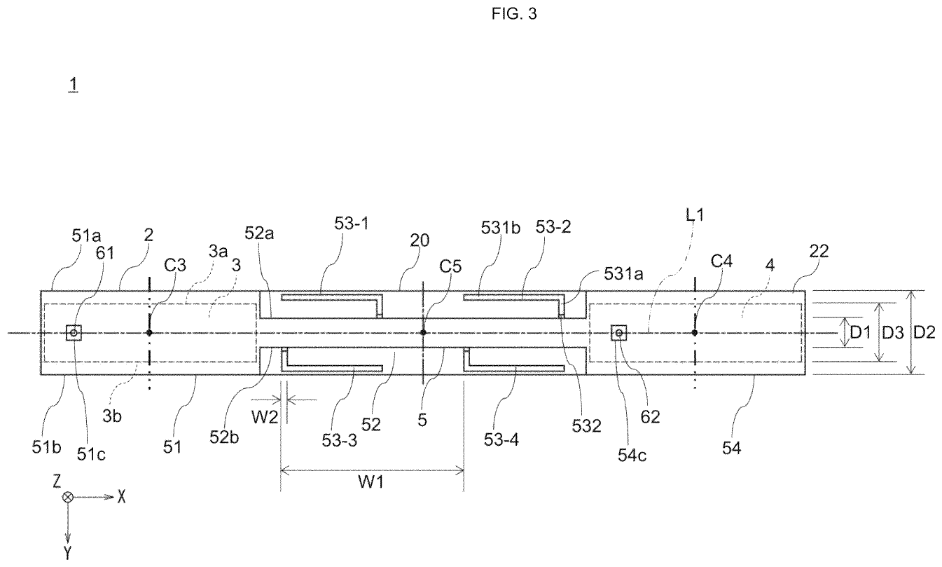

FIG. 2 is a plan view of the antenna substrate 1. FIG. 3 is a bottom view of the antenna substrate 1.

As shown in FIGS. 1, 2, and 3, the antenna substrate 1 includes a baseplate 2, a first radiation electrode 3, a second radiation electrode 4, a ground portion 5, a first feed point 61, and a second feed point 62.

The baseplate 2 has a thickness. In the embodiment, a direction of the baseplate 2 along a thickness direction is a first direction Z. Two directions of the baseplate 2 that are orthogonal to each other when seen from the first direction Z are a second direction X and a third direction Y. In the embodiment, the second direction X and the third direction Y are each orthogonal to the first direction Z. In the embodiment, the baseplate 2 has a rectangular plate shape. For example, the second direction X is a length direction of the baseplate 2, and the third direction Y is a width direction of the baseplate 2.

As shown in FIG. 1, the baseplate 2 includes a dielectric layer 20. The dielectric layer 20 has a first main surface 21 and a second main surface 22 that is situated on a side opposite to the first main surface 21. The first main surface 21 and the second main surface 22 are, for example, two surfaces in the thickness direction of the dielectric layer 20. The baseplate 2 includes a protective layer 23. The protective layer 23 has an electrically insulating property, and covers the second main surface 22 of the dielectric layer 20. Note that, for making it easier to read the figures, the protective layer 23 is sometimes not illustrated.

The baseplate 2 is, for example, a dielectric baseplate. Examples of the dielectric baseplate include a low temperature co-fired ceramics (LTCC) multilayer baseplate; a multilayer resin baseplate that is formed by laminating a plurality of resin layers made of resin, such as epoxy resin or polyimide resin; a multilayer resin baseplate that is formed by laminating a plurality of resin layers made of liquid crystal polymer (LCP) having a lower dielectric constant; a multilayer resin baseplate that is formed by laminating a plurality of resin layers made of fluorine-based resin; and a ceramics multilayer baseplate other than LTCC.

As shown in FIG. 2, the first radiation electrode 3 and the second radiation electrode 4 are positioned on the first main surface 21 of the dielectric layer 20 of the baseplate 2. The first radiation electrode 3 and the second radiation electrode 4 are disposed side by side (coplanar) and apart from each other on the first main surface 21 of the dielectric layer 20 in the second direction X. When seen from the first direction Z, the second radiation electrode 4 is disposed on the baseplate 2 so as to be spatially apart from the first radiation electrode 3 in the second direction X. In FIG. 2, the first radiation electrode 3 and the second radiation electrode 4 exist on a corresponding one of two ends of the dielectric layer 20 of the baseplate 2 in the second direction X. As described above, the second direction X is the length direction of the baseplate 2, and the third direction Y is the width direction of the baseplate 2. This structure makes it possible to reduce the size of the baseplate 2.

The first radiation electrode 3 is a conductive pattern that is formed on the first main surface 21 of the dielectric layer 20. The first radiation electrode 3 has a planar shape. The first radiation electrode 3 in FIG. 2 has a substantially rectangular shape when seen from the first direction Z. As shown in FIG. 2, when seen from the first direction Z, the first radiation electrode 3 is line-symmetrical with respect to a line that extends through a center C3 of the first radiation electrode 3 and that is parallel to the second direction X.

The second radiation electrode 4 is a conductive pattern that is formed on the first main surface 21 of the dielectric layer 20. The second radiation electrode 4 has a planar shape. The second radiation electrode 4 in FIG. 2 has a substantially rectangular shape when seen from the first direction Z. As shown in FIG. 2, when seen from the first direction Z, the second radiation electrode 4 is line-symmetrical with respect to a line that extends through a center C4 of the second radiation electrode 4 and that is parallel to the second direction X. In the embodiment, as shown in FIG. 2, when seen from the first direction Z, the center C3 of the first radiation electrode 3 and the center C4 of the second radiation electrode 4 are disposed side by side along the second direction X. That is, a straight line that connects the center C3 of the first radiation electrode 3 and the center C4 of the second radiation electrode 4 is parallel to the second direction X.

The shape of the first radiation electrode 3 and the shape of the second radiation electrode 4 are determined in accordance with a frequency band that is used in radio communications. In the embodiment, the first radiation electrode 3 and the second radiation electrode 4 have the same shape. An example of a frequency band of radio communications is a frequency band of radio communications by Wi-Fi. Examples of frequency bands of radio communications by Wi-Fi include a frequency band near 2.4 GHz (for example, 2.4 GHz to 2.5 GHz) and a frequency band near 5 GHz (for example, 5.15 GHz to 5.8 GHz).

When the size of each of the first radiation electrode 3 and the second radiation electrode 4 in the third direction Y is increased, the width of the frequency band of radio communications can be increased. On the other hand, the first radiation electrode 3 and the second radiation electrode 4 exist on a corresponding one of the two ends of the dielectric layer 20 of the baseplate 2 in the second direction X. Therefore, when the size of each of the first radiation electrode 3 and the second radiation electrode 4 in the third direction Y is decreased, it is possible to reduce the size of the baseplate 2 in the third direction Y.

As shown in FIG. 3, the ground portion 5 is positioned on the second main surface 22 of the dielectric layer 20 of the baseplate 2. The ground portion 5 is a ground portion that is common to the first radiation electrode 3 and the second radiation electrode 4. The ground portion 5 is used as ground with respect to the first radiation electrode 3 and the second radiation electrode 4.

The ground portion 5 includes a ground electrode 51, a connection line 52, and a plurality of stubs 53-1 to 53-4 (may be collectively denoted by reference numeral 53 below). Further, the ground portion 5 includes a ground electrode 54 that differs from the ground electrode 51. In order to clearly distinguish between the ground electrodes 51 and 54, the ground electrode 51 may be called a first ground electrode 51, and the ground electrode 54 may be called a second ground electrode 54.

As shown in FIG. 3, the first ground electrode 51 and the second ground electrode 54 are disposed side by side and apart from each other on the second main surface 22 of the dielectric layer 20 in the second direction X. The first ground electrode 51 and the second ground electrode 54 exist on a corresponding one of two ends of the dielectric layer 20 of the baseplate 2 in the second direction X.

The first ground electrode 51 faces the first radiation electrode 3 when seen from the first direction Z. The first radiation electrode 3 and the first ground electrode 51 constitute a planar antenna (patch antenna). The first ground electrode 51 is a conductive pattern that is formed on the second main surface 22 of the dielectric layer 20. The first ground electrode 51 has a planar shape. The first ground electrode 51 has a substantially rectangular shape when seen from the first direction Z. The size of the first ground electrode 51 is larger than the size of the first radiation electrode 3. When seen from the first direction Z, the first radiation electrode 3 fits within an inner side of the first ground electrode 51.

The second ground electrode 54 faces the second radiation electrode 4 when seen from the first direction Z. The second radiation electrode 4 and the second ground electrode 54 constitute a planar antenna (patch antenna). The second ground electrode 54 is a conductive pattern that is formed on the second main surface 22 of the dielectric layer 20. The second ground electrode 54 has a planar shape. The second ground electrode 54 has a substantially rectangular shape when seen from the first direction Z. The size of the second ground electrode 54 is larger than the size of the second radiation electrode 4. When seen from the first direction Z, the second radiation electrode 4 fits within an inner side of the second ground electrode 54.

In the antenna substrate 1, the first ground electrode 51, together with the first radiation electrode 3, constitutes a planar antenna (patch antenna), and the second ground electrode 54, together with the second radiation electrode 4, constitutes a planar antenna (patch antenna). These structures make it possible to improve electrical symmetry in the antenna substrate 1 and contribute to improving antenna characteristics and isolation characteristics between the first radiation electrode 3 and the second radiation electrode 4. Further, since the antenna substrate 1 includes the same type of antennas (patch antennas), it is possible to increase antenna gain in the first direction Z.

In the embodiment, the first ground electrode 51 and the second ground electrode 54 have the same shape.

The connection line 52 exists between the first radiation electrode 3 and the second radiation electrode 4 when seen from the first direction Z. In the embodiment, the connection line 52 exists between the first ground electrode 51 and the second ground electrode 54 when seen from the first direction Z. More specifically, the connection line 52 connects the first ground electrode 51 and the second ground electrode 54 to each other. In other words, the connection line 52 has a shape extending from the first ground electrode 51 to the second ground electrode 54 along the second direction X. The connection line 52 is a conductive pattern that is formed on the second main surface 22 of the dielectric layer 20. In the embodiment, the first ground electrode 51, the second ground electrode 54, and the connection line 52 are continuously integrally formed.

When seen from the first direction Z, the center C3 of the first radiation electrode 3 and a center C5 of the connection line 52 are disposed side by side along the second direction X. A straight line Li that connects the center C3 of the first radiation electrode 3 and the center C5 of the connection line 52 is parallel to the second direction X. This structure makes it easier for a distribution of electrical current that flows through the connection line 52 to become line-symmetrical with respect to the straight line Li. Therefore, it is possible to further improve isolation characteristics between the first radiation electrode 3 and the second radiation electrode 4.

The connection line 52 has a shape that is line-symmetrical with respect to a line that extends through the center C3 of the first radiation electrode 3 and that is parallel to the second direction X. This structure makes it easier for a distribution of electrical current that flows through the connection line 52 to become line-symmetrical with respect to a line that extends through the center C5 of the connection line 52 and that is parallel to the second direction X. Therefore, it is possible to further improve isolation characteristics between the first radiation electrode 3 and the second radiation electrode 4.

The connection line 52 has a planar shape. The connection line 52 has a substantially rectangular shape when seen from the first direction Z. The connection line 52 has a first side 52a and a second side 52b that face each other in the third direction Y. In the embodiment, the first side 52a and the second side 52b are parallel to the second direction X. The size of the connection line 52 is smaller than the size of the first ground electrode 51 in the third direction Y. As shown in FIG. 3, a dimension D1 of the connection line 52 in the third direction Y (that is, the distance between the first side 52a and the second side 52b) is less than a dimension D2 of the first ground electrode 51 in the third direction Y. The dimension D2 is a distance between a first side 51a and a second side 51b of the first ground electrode 51 that face each other in the third direction Y. This structure makes it easier for electrical current to concentrate in the connection line 52 than in the first ground electrode 51. In the embodiment, the first ground electrode 51 has a substantially rectangular shape, and the first side 51a and the second line 51b are parallel to the second direction X. Therefore, the first side 51a of the first ground electrode 51 is parallel to the first side 52a of the connection line 52, and the second side 51b of the first ground electrode 51 is parallel to the second side 52b of the connection line 52. The first side 51a of the first ground electrode 51 exists on the same side as the first side 52a of the connection line 52 (a side in a direction opposite to the third direction Y). The second side 51b of the first ground electrode 51 exists on the same side as the second side 52b of the connection line 52 (a side in the third direction Y).

The size of the connection line 52 is smaller than the size of the first radiation electrode 3 in the third direction Y. As shown in FIG. 3, the dimension D1 of the connection line 52 in the third direction Y is less than a dimension D3 of the first radiation electrode 3 in the third direction Y. The dimension D3 is a distance between a first side 3a and a second side 3b of the first radiation electrode 3 that face each other in the third direction Y. This structure makes it possible to reduce the size of the baseplate 2 in the third direction Y. In the embodiment, the first radiation electrode 3 has a substantially rectangular shape, and the first side 3a and the second side 3b are parallel to the second direction X. Therefore, the first side 3a of the first radiation electrode 3 is parallel to the first side 52a of the connection line 52, and the second side 3b of the first radiation electrode 3 is parallel to the second side 52b of the connection line 52. The first side 3a of the first radiation electrode 3 exists on the same side as the first side 52a of the connection line 52 (a side in a direction opposite to the third direction Y). The second side 3b of the first radiation electrode 3 exists on the same side as the second side 52b of the connection line 52 (a side in the third direction Y).

The stubs 53 are each connected to one of the first side 52a and the second side 52b of the connection line 52. The stubs 53 are provided for improving isolation characteristics between the first radiation electrode 3 and the second radiation electrode 4. The stubs 53 are a distributed constant circuit. The stubs 53 are open stubs whose end is open. The resonant frequency of each open stub is a frequency in which an electrical length of the open stub becomes a ¼ wavelength. Each stub 53 can attenuate a high-frequency signal at the connection line 52 near its resonant frequency. Therefore, it is possible to improve isolation characteristics between the first radiation electrode 3 and the second radiation electrode 4. As an example, the resonant frequency of each stub 53 is set based on the frequency band of a high-frequency signal that is supplied to each of the first radiation electrode 3 and the second radiation electrode 4.

As described above, since the dimension D1 of the connection line 52 is less than the dimension D2 of the first ground electrode 51, electrical current more easily concentrates in the connection line 52 than in the first ground electrode 51. Since the stubs 53 are connected to the connection line 52 instead of being connected to the first ground electrode 51, electrical current easily flows through the stubs 53. Therefore, it is possible to efficiently improve isolation characteristics between the first radiation electrode 3 and the second radiation electrode 4. Further, since the stubs 53 are connected to the connection line 52 instead of being connected to the first ground electrode 51, the length of each stub 53 can be set independently of the ground electrode 51. Therefore, unlike a structure having slots in a ground plane as in Patent Document 1, the size of the ground electrode 51 need not be increased for forming sufficiently long stubs 53. Therefore, it is possible to reduce the size of the antenna substrate 1.

In this way, the antenna substrate 1 can be reduced in size while making it possible to improve isolation characteristics between the first radiation electrode 3 and the second radiation electrode 4.

In the embodiment, the ground portion 5 includes the plurality of stubs 53, that is, four stubs 53-1 to 53-4.

First, the structure of each stub 53 is described. As shown in FIG. 3, the stubs 53-1, 53-2, 53-3, and 53-4 have the same structure. Each stub 53 has a bent shape. In particular, each stub 53 has an L shape when seen from the first direction Z. Each stub 53 includes conductive paths 531a and 531b and a chip component 532.

The conductive paths 531a and 531b are formed on the baseplate 2. The conductive paths 531a and 531b are conductive patterns that are formed on the second main surface 22 of the dielectric layer 20. More specifically, each conductive path 531a extends along the third direction Y from the connection line 52. Each conductive path 531b extends along the second direction X from an end of a corresponding one of the conductive paths 531a. The conductive paths 531a and 531b each have a linear shape.

In each of the stubs 53-1 and 53-2, the conductive path 531a extends in a direction opposite to the third direction Y from the first side 52a of the connection line 52. Each conductive path 531a is not directly connected to the connection line 52. In each of the stubs 53-1 and 53-2, the conductive path 531b extends in a direction opposite to the second direction X from an end (upper end in FIG. 3) of a corresponding one of the conductive paths 531a.

In each of the stubs 53-3 and 53-4, the conductive path 531a extends in the third direction Y from the second side 52b of the connection line 52. Each conductive path 531a is not directly connected to the connection line 52. Each conductive path 531b extends in the second direction X from an end (lower end in FIG. 3) of a corresponding one of the conductive paths 531a.

A physical length of each of the conductive paths 531a and 531b is set as appropriate in accordance with a target electrical length of each stub 53. In the embodiment, the physical length of each conductive path 531a is less than a physical length of each conductive path 531b. In particular, the physical length of each conductive path 531a is set such that the stubs 53 fit within an inner side of the first ground electrode 51 in the third direction Y when seen from the second direction X. More specifically, in the third direction Y, the stubs 53-1 and 53-2 fit between a side (the first side 52a) of the connection line 52 to which the stubs 53-1 and 53-2 are connected and a side (the first side 51a) of the first ground electrode 51 that exists on the same side as the side (the first side 52a) of the connection line 52 to which the stubs 53-1 and 53-2 are connected. In the third direction Y, the stubs 53-3 and 53-4 fit between a side (the second side 52b) of the connection line 52 to which the stubs 53-3 and 53-4 are connected and a side (the second side 51b) of the first ground electrode 51 that exists on the same side as the side (the second side 52b) of the connection line 52 to which the stubs 53-3 and 53-4 are connected. This structure makes it possible to reduce the size of the baseplate 2 in the third direction Y.

Each chip component 532 is mounted on the baseplate 2. Each chip component 532 is mounted on the second main surface 22 of the dielectric layer 20. Each chip component 532 exists between a corresponding one of the conductive paths 531a and the connection line 52. That is, each chip component 532 is mounted on the baseplate 2 so as to connect a corresponding one of the conductive paths 531a and the connection line 52 to each other. Each chip component 532 includes at least one or more of an inductor, a capacitor, or a 0Ω resistor. This structure makes it easier to set the resonant frequency of each stub 53. That is, even without changing the physical length of each of the conductive paths 531a and 531b, it is possible to adjust the electrical length of each stub 53 by changing the chip components 532 as appropriate. A structure in which each chip component 532 exists between a corresponding one of the conductive paths 531a and the connection line 52 makes it possible to further facilitate the setting of the resonant frequency of each stub 53.

In each stub 53, the conductive path 531b extends along the second direction X. That is, at least part of each stub 53 extends along the second direction X. Capacitance can be produced between the connection line 52 and a portion (the conductive path 531b) of each stub 53 extending along the second direction X. The capacitance that is produced between each stub 53 and the connection line 52 can influence the resonant frequency of each stub 53. The capacitance that is produced between each stub 53 and the connection line 52 may be increased when the length of the portion of each stub 53 extending along the second direction X is increased or when the distance between the connection line 52 and the portion of each stub 53 extending along the second direction X is decreased. When the capacitance that is produced between each stub 53 and the connection line 52 is increased, even if the electrical length of each stub 53 is the same, the resonant frequency tends to increase. Therefore, this structure makes it possible to decrease the electrical length of each stub 53 required to set the resonant frequency of each stub 53 to a target resonant frequency.

Next, the arrangement of the stubs 53 is described.

The ground portion 5 includes the plurality of stubs 53, that is, the four stubs 53-1 to 53-4. The stubs 53-1 and 53-2 are each connected to the first side 52a of the connection line 52, and the stubs 53-3 and 53-4 are each connected to the second side 52b of the connection line 52. Hereunder, the stubs that are connected to the first side 52a may be called first stubs, and the stubs that are connected to the second side 52b may be called second stubs. In FIG. 3, the stubs 53-1 and 53-2 are the first stubs, and the stubs 53-3 and 53-4 are the second stubs. This structure makes it possible to improve electrical symmetry in the antenna substrate 1 and contributes to improving antenna characteristics and isolation characteristics between the first radiation electrode 3 and the second radiation electrode 4.

As described above, the connection line 52 has a shape that is line-symmetrical with respect to the line that extends through the center C3 of the first radiation electrode 3 and that is parallel to the second direction X. Therefore, the distribution of electrical current that flows through the connection line 52 easily becomes line-symmetrical with respect to the line that extends through the center C5 of the connection line 52 and that is parallel to the second direction X. Thus, electrical current easily flows uniformly through the first stubs and the second stubs. Consequently, it is possible to further improve isolation characteristics between the first radiation electrode 3 and the second radiation electrode 4. In the embodiment, since the connection line 52 has a shape that is line-symmetrical with respect to the line that extends through the center C3 of the first radiation electrode 3 and that is parallel to the second direction X, electrical current easily flows more uniformly through the first stubs and the second stubs.

The number of first stubs is two. The number of second stubs is two. The number of first stubs and the number of second stubs are equal to each other. This structure makes it possible to improve electrical symmetry in the antenna substrate 1 and contributes to improving antenna characteristics and isolation characteristics between the first radiation electrode 3 and the second radiation electrode 4.

First connection positions of one or more first stubs, that is, the first stubs 53-1 and 53-2, with the connection line 52 and second connection positions of one or more second stubs, that is, the second stubs 53-3 and 53-4, with the connection line 52 differ from each other in the second direction X. More specifically, the first connection positions of the first stubs 53-1 and 53-2 with the connection line 52 (the positions of the chip components 532 of the stubs 53-1 and 53-2) differ in the second direction X from the second connection positions of the second stubs 53-3 and 53-4 with the connection line 52 (the positions of the chip components 532 of the stubs 53-3 and 53-4). When the first connection positions and the second connection positions correspond to each other in the second direction X, electrical current to be directed toward the second stubs 53-3 and 53-4 from the first side 52a of the connection line 52 and electrical current to be directed toward the first stubs 53-1 and 53-2 from the second side 52b of the connection line 52 cancel each other out, as a result of which the amount of electrical current that flows in the stubs 53 may decrease. In FIG. 3, the first connection positions and the second connection positions differ from each other in the second direction X. This structure makes it possible to cause electrical current to flow efficiently from the first side 52a of the connection line 52 to the first stubs 53-1 and 53-2 and to cause electrical current to flow efficiently from the second side 52b of the connection line 52 to the second stubs 53-3 and 53-4. Therefore, this structure makes it possible to further improve isolation characteristics between the first radiation electrode 3 and the second radiation electrode 4. The first connection positions and the second connection positions are in a point-symmetrical relationship with respect to the center C5 of the connection line 52 when seen from the first direction Z. This structure makes it possible to further improve isolation characteristics between the first radiation electrode 3 and the second radiation electrode 4.

Two or more stubs, that is, the stubs 53-1 and 53-2, of the four stubs 53-1 to 53-4 are connected to the same side (the first side 52a) of the connection line 52 and are disposed side by side along the second direction X. This structure makes it possible to further improve isolation characteristics between the first radiation electrode 3 and the second radiation electrode 4. The remaining two or more stubs, that is, the stubs 53-3 and 53-4, of the four stubs 53-1 to 53-4 are connected to a different side (the second side 52b) of the connection line 52 and are disposed side by side along the second direction X. This structure makes it possible to further improve isolation characteristics between the first radiation electrode 3 and the second radiation electrode 4.

An interval W1 between two or more stubs 53 in the second direction X is greater than a width W2 of each of the two or more stubs 53. In FIG. 3, the interval W1 between the stubs 53-3 and 53-4 in the second direction X is greater than the width W2 of each of the stubs 53-3 and 53-4. Here, the width W2 of each of the stubs 53-3 and 53-4 is the width of a corresponding one of the conductive paths 531a. The width of each conductive path 531a may be equal to the width of a corresponding one of the conductive paths 531b. Although not shown clearly in FIG. 3, the interval between the stubs 53-1 and 53-2 in the second direction X is also greater than the width of each of the stubs 53-1 and 53-2. This structure makes it possible to decrease a reduction in the performance caused by interaction (for example, capacitive coupling) between the two or more stubs 53 in the second direction X. Therefore, it is possible to further improve isolation characteristics between the first radiation electrode 3 and the second radiation electrode 4.

The first feed point 61 is a feed point of the first radiation electrode 3. The first feed point 61 is used to supply a high-frequency signal to the first radiation electrode 3. As an example, an inner conductor of a coaxial cable is connected to the first radiation electrode 3 through the first feed point 61. As shown in FIG. 1, the first feed point 61 is a through-hole wire that extends through the dielectric layer 20 of the baseplate 2. A first end of the first feed point 61 is exposed at the first main surface 21 of the dielectric layer 20 and is connected to the first radiation electrode 3. A second end of the first feed point 61 is exposed at the second main surface 22 of the dielectric layer 20, and is not connected to the first ground electrode 51. In FIG. 3, the first ground electrode 51 has an opening 51c around the first feed point 61 in the second main surface 22 so as to be isolated from the first feed point 61. In the embodiment, when seen from the first direction Z, the center C3 of the first radiation electrode 3 and the first feed point 61 (the feed point of the first radiation electrode 3) are disposed side by side along the second direction X. This structure makes it possible to cause a direction in which the size of the first radiation electrode 3 is adjusted in accordance with the frequency band of radio communication that uses the first radiation electrode 3 to be the second direction X instead of the third direction Y. Therefore, this is structure makes it possible to reduce the size of the baseplate 2 in the third direction Y.

The second feed point 62 is a feed point of the second radiation electrode 4. The second feed point 62 is used to supply a high-frequency signal to the second radiation electrode 4. As an example, an inner conductor of a coaxial cable is connected to the second radiation electrode 4 through the second feed point 62. As shown in FIG. 1, the second feed point 62 is a through-hole wire that extends through the dielectric layer 20 of the baseplate 2. A first end of the second feed point 62 is exposed at the first main surface 21 of the dielectric layer 20 and is connected to the second radiation electrode 4. A second end of the second feed point 62 is exposed at the second main surface 22 of the dielectric layer 20, and is not connected to the second ground electrode 54. In FIG. 3, the second ground electrode 54 has an opening 54c around the second feed point 62 in the second main surface 22 so as to be isolated from the second feed point 62. In the embodiment, when seen from the first direction Z, the center C4 of the second radiation electrode 4 and the second feed point 62 (the feed point of the second radiation electrode 4) are disposed side by side along the second direction X. This structure makes it possible to cause a direction in which the size of the second radiation electrode 4 is adjusted in accordance with the frequency band of radio communication that uses the second radiation electrode 4 to be the second direction X instead of the third direction Y. Therefore, this structure makes it possible to reduce the size of the baseplate 2 in the third direction Y.

In FIG. 3, the first feed point 61 exists on a side in a direction opposite to the second direction X from the center C3 of the first radiation electrode 3, and the second feed point 62 exists on a side in a direction opposite to the second direction X from the center C4 of the second radiation electrode 4. That is, the first feed point 61 and the second feed point 62 exist on the same side with respect to the center of a corresponding one of the radiation electrodes. The first feed point 61 and the second feed point 62 may exist on the opposite side with respect to the center of the corresponding one of the radiation electrodes. As an example, the second feed point 62 may exist on a side in the direction of the second direction X from the center C4 of the second radiation electrode 4. The positional relationship between each feed point and the center of the corresponding one of the radiation electrodes is not particularly limited, and may be set as appropriate in accordance with the distance between the radiation electrodes and the length of a wavelength corresponding to a frequency band of radio communication that uses the radiation electrodes. However, in order to prevent the generation of noise, the position of each feed point is situated so as not to overlap the positions of nth harmonic waves (where n is an integer greater than or equal to 2), such as a second harmonic wave or a third harmonic wave, with respect to the aforementioned wavelength at the radiation electrode.

As shown in FIG. 1, the electronic components 11 and 12 are mounted on the antenna substrate 1. More specifically, the electronic components 11 and 12 are disposed on the protective layer 23 of the baseplate 2 of the antenna substrate 1. The electronic component 11 is, for example, a processing circuit including an IC. An example of the processing circuit is an SiP (System in Package). The electronic component 11 executes, for example, an operation for performing radio communication using the antenna substrate 1. The electronic component 11 is connected to the first feed point 61 and the second feed point 62. The electronic component 11 is capable of outputting a high-frequency signal to the first radiation electrode 3 and the second radiation electrode 4 through the first feed point 61 and the second feed point 62. The electronic component 11 is capable of receiving a high-frequency signal from the first radiation electrode 3 and the second radiation electrode 4 through the first feed point 61 and the second feed point 62. The electronic component 12 is, for example, a connector. The electronic component 12 is used to connect the antenna module 10 and an external device (such as a control circuit of a unit that includes the antenna module 10).

### 1.1.2 Effects, Etc.

The antenna substrate 1 described above includes the baseplate 2, the planar-shaped first radiation electrode 3 that is disposed on the baseplate 2, the second radiation electrode 4 that is disposed on the baseplate 2 so as to be spatially apart from the first radiation electrode 3 in the second direction X when seen from the first direction Z along the thickness direction of the baseplate 2, and the ground portion 5 that is disposed on the baseplate 2 and that is common to the first radiation electrode 3 and the second radiation electrode 4. The ground portion 5 includes the ground electrode 51 that faces the first radiation electrode 3 when seen from the first direction Z, the connection line 52 that exists between the first radiation electrode 3 and the second radiation electrode 4 when seen from the first direction Z and that has a size that is smaller than the size of the ground electrode 51 in the third direction Y orthogonal to the second direction X when seen from the first direction Z, and the stubs 53 that are each connected to one of the first side 52a and the second side 52b of the connection line 52 that face each other in the third direction Y. This structure makes it possible to realize size reduction while making it possible to improve isolation characteristics between the first radiation electrode 3 and the second radiation electrode 4.

In the antenna substrate 1, the size of the connection line 52 is smaller than the size of the first radiation electrode 3 in the third direction Y. This structure makes it possible to reduce the size of the baseplate 2 in the third direction Y.

In the antenna substrate 1, the ground portion 5 includes the plurality of stubs 53. The plurality of stubs 53 include one or more first stubs, that is, the first stubs 53-1 and 53-2, that are connected to the first side 52a of the connection line 52, and one or more second stubs, that is, the second stubs 53-3 and 53-4, that are connected to the second side 52b of the connection line 52. This structure makes it possible to improve electrical symmetry in the antenna substrate 1 and contributes to improving antenna characteristics and isolation characteristics between the first radiation electrode 3 and the second radiation electrode 4.

In the antenna substrate 1, the number of one or more first stubs, that is, the first stubs 53-1 and 53-2, and the number of one or more second stubs, that is, the second stubs 53-3 and 53-4, are equal to each other. This structure makes it possible to improve electrical symmetry in the antenna substrate 1 and contributes to improving antenna characteristics and isolation characteristics between the first radiation electrode 3 and the second radiation electrode 4.

In the antenna substrate 1, the first connection positions of one or more first stubs, that is, the first stubs 53-1 and 53-2, with the connection line 52 and the second connection positions of one or more second stubs, that is, the second stubs 53-3 and 53-4, with the connection line 52, differ from each other in the second direction X. This structure makes it possible to further improve isolation characteristics between the first radiation electrode 3 and the second radiation electrode 4.

In the antenna substrate 1, the first connection positions and the second connection positions are in a point-symmetrical relationship with respect to the center C5 of the connection line 52 when seen from the first direction Z. This structure makes it possible to further improve isolation characteristics between the first radiation electrode 3 and the second radiation electrode 4.

In the antenna substrate 1, each stub 53 includes one or more conductive paths, that is, the conductive paths 531a and 531b, that are formed on the baseplate 2, and one or more chip components, that is, the chip component 532, that is formed on the baseplate 2; and the one or more chip components 532 include at least one or more of an inductor, a capacitor, or a 0Ω resistor. This structure makes it easier to set the resonant frequency of each stub 53.

In the antenna substrate 1, at least one of the one or more chip components 532 exists between one or more conductive paths, that is, the conductive paths 531a and 531b, and the connection line 52. This structure makes it even easier to set the resonant frequency of each stub 53.

In the antenna substrate 1, at least part 531b of each stub 53 extends along the second direction X. This structure makes it possible to decrease the electrical length of each stub 53 required to set the resonant frequency of each stub 53 to a target resonant frequency.

In the antenna substrate 1, when seen from the first direction Z, the center C3 of the first radiation electrode 3 and the center C5 of the connection line 52 are disposed side by side along the second direction X. This structure makes it possible to further improve isolation characteristics between the first radiation electrode 3 and the second radiation electrode 4.

In the antenna substrate 1, when seen from the first direction Z, the connection line 52 has a shape that is line-symmetrical with respect to the line that extends through the center C3 of the first radiation electrode 3 and that is parallel to the second direction X. This structure makes it possible to further improve isolation characteristics between the first radiation electrode 3 and the second radiation electrode 4.

In the antenna substrate 1, when seen from the first direction Z, the center C3 of the first radiation electrode 3 and the feed point 61 of the first radiation electrode 3 are disposed side by side along the second direction X. This structure makes it possible to reduce the size of the baseplate 2 in the third direction Y.

In the antenna substrate 1, when seen from the first direction Z, the center C4 of the second radiation electrode 4 and the feed point 62 of the second radiation electrode 4 are disposed side by side along the second direction X. This structure makes it possible to reduce the size of the baseplate 2 in the third direction Y.

In the antenna substrate 1, the ground portion 5 includes the plurality of stubs 53, and two or more stubs 53, that is, the stubs 53-1 and 53-2, of the plurality of stubs 53 are connected to the first side 52a of the connection line 52 and are disposed side by side along the second direction X. Two or more stubs 53, that is, the stubs 53-3 and 53-4, of the plurality of stubs 53 are connected to the second side 52b of the connection line 52 and are disposed side by side along the second direction X. This structure makes it possible to further improve isolation characteristics between the first radiation electrode 3 and the second radiation electrode 4.

In the antenna substrate 1, the interval W1 between two or more stubs 53 in the second direction X is greater than the width W2 of each of the two or more stubs 53. This structure makes it possible to further improve isolation characteristics between the first radiation electrode 3 and the second radiation electrode 4.

In the antenna substrate 1, the second radiation electrode 4 has a planar shape, the ground electrode 51 is the first ground electrode 51, the ground portion 5 includes the second ground electrode 54 that faces the second radiation electrode 4 when seen from the first direction Z, and the connection line 52 connects the first ground electrode 51 and the second ground electrode 54 to each other. This structure makes it possible to improve electrical symmetry in the antenna substrate 1 and contributes to improving antenna characteristics and isolation characteristics between the first radiation electrode 3 and the second radiation electrode 4.

In the antenna substrate 1, the second direction X is the length direction of the baseplate 2, and the third direction Y is the width direction of the baseplate 2. This structure makes it possible to reduce the size of the baseplate 2.

The antenna module 10 described above includes the antenna substrate 1 and the electronic components 11 and 12 that are mounted on the antenna substrate 1. This structure makes it possible to realize size reduction while making it possible to improve isolation characteristics between the first radiation electrode 3 and the second radiation electrode 4.

### 1.2 Second Embodiment

### 1.2.1 Structure

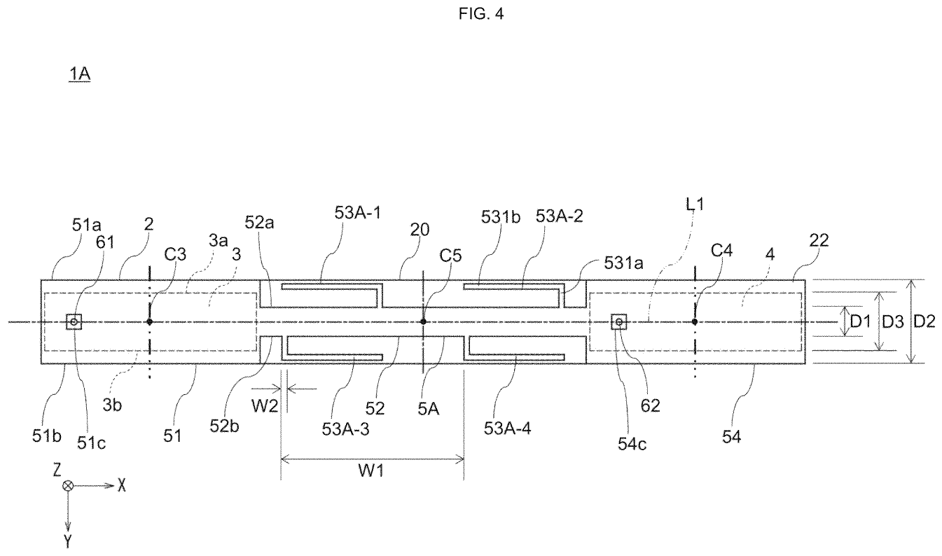

FIG. 4 is a bottom view of an example of a structure of an antenna substrate 1A according to a second embodiment. Instead of the antenna substrate 1, the antenna substrate 1A is used in an antenna module 10. The antenna substrate 1A includes a baseplate 2, a first radiation electrode 3, a second radiation electrode 4, a ground portion 5A, a first feed point 61, and a second feed point 62.

The ground portion 5A includes a ground electrode 51, a connection line 52, and a plurality of stubs 53A-1 to 53A-4 (may be collectively denoted by reference numeral 53A below). Further, the ground portion 5A includes a second ground electrode 54 that differs from the first ground electrode 51.

The stubs 53A are each connected to one of a first side 52a and a second side 52b of the connection line 52 that face each other in the third direction Y.

First, the structure of each stub 53A is described. The stubs 53A-1, 53A-2, 53A-3, and 53A-4 have the same structure. Each stub 53A has a bent shape. In particular, each stub 53A has an L shape when seen from the first direction Z. Each stub 53A includes conductive paths 531a and 531b. Unlike each stub 53, each stub 53A does not include a chip component 532. This structure makes it possible to simplify the structure of each stub 53A.

In each of the stubs 53A-1 and 53A-2, the conductive path 531a extends in a direction opposite to the third direction Y from the first side 52a of the connection line 52. Each conductive path 531a is directly connected to the connection line 52. In each of the stubs 53A-1 and 53A-2, the conductive path 531b extends in a direction opposite to the second direction X from an end (upper end in FIG. 4) of a corresponding one of the conductive paths 531a.

In each of the stubs 53A-3 and 53A-4, the conductive path 531a extends in the third direction Y from the second side 52b of the connection line 52. Each conductive path 531a is directly connected to the connection line 52. Each conductive path 531b extends in the second direction X from an end (lower end in FIG. 4) of a corresponding one of the conductive paths 531a.

A physical length of each of the conductive paths 531a and 531b is set as appropriate in accordance with a target electrical length of each stub 53A. In the embodiment, the physical length of each conductive path 531a is less than a physical length of each conductive path 531b. In particular, in the embodiment, the physical length of each conductive path 531a is set such that the stubs 53A fit within an inner side of the first ground electrode 51 in the third direction Y when seen from the second direction X. This structure makes it possible to reduce the size of the baseplate 2 in the third direction Y.

In each stub 53A, the conductive path 531b extends along the second direction X. That is, at least part of each stub 53A extends along the second direction X. This structure makes it possible to decrease the electrical length of each stub 53A required to set the resonant frequency of each stub 53A to a target resonant frequency.

Next, the arrangement of the stubs 53A is described.

The stubs 53A-1 and 53A-2 are each connected to the first side 52a of the connection line 52, and the stubs 53A-3 and 53A-4 are each connected to the second side 52b of the connection line 52. The stubs 53A-1 and 53A-2 are first stubs, and the stubs 53A-3 and 53A-4 are second stubs. This structure makes it possible to improve electrical symmetry in the antenna substrate 1A and contributes to improving antenna characteristics and isolation characteristics between the first radiation electrode 3 and the second radiation electrode 4. The number of first stubs is two. The number of second stubs is two. The number of first stubs and the number of second stubs are equal to each other. This structure makes it possible to improve electrical symmetry in the antenna substrate 1A and contributes to improving antenna characteristics and isolation characteristics between the first radiation electrode 3 and the second radiation electrode 4.

First connection positions of one or more first stubs, that is, the first stubs 53A-1 and 53A-2, with the connection line 52 and second connection positions of one or more second stubs, that is, the second stubs 53A-3 and 53A-4, with the connection line 52 differ from each other in the second direction X. This structure makes it possible to further improve isolation characteristics between the first radiation electrode 3 and the second radiation electrode 4. The first connection positions and the second connection positions are in a point-symmetrical relationship with respect to a center C5 of the connection line 52 when seen from the first direction Z. This structure makes it possible to further improve isolation characteristics between the first radiation electrode 3 and the second radiation electrode 4.

Two or more stubs, that is, the stubs 53A-1 and 53A-2, of the four stubs 53A-1 to 53A-4 are connected to the same side (the first side 52a) of the connection line 52 and are disposed side by side along the second direction X. This structure makes it possible to further improve isolation characteristics between the first radiation electrode 3 and the second radiation electrode 4. The remaining two or more stubs, that is, the stubs 53A-3 and 53A-4, of the four stubs 53A-1 to 53A-4 are connected to a different side (the second side 52b) of the connection line 52 and are disposed side by side along the second direction X. This structure makes it possible to further improve isolation characteristics between the first radiation electrode 3 and the second radiation electrode 4.

An interval W1 between two or more stubs 53A in the second direction X is greater than a width W2 of each of the two or more stubs 53A. In FIG. 4, the interval W1 between the stubs 53A-3 and 53A-4 in the second direction X is greater than the width W2 of each of the stubs 53A-3 and 53A-4. Here, the width W2 of each of the stubs 53A-3 and 53A-4 is the width of a corresponding one of the conductive paths 531a. The width of each conductive path 531a may be equal to the width of a corresponding one of the conductive paths 531b. Although not shown clearly in FIG. 4, the interval between the stubs 53A-1 and 53A-2 in the second direction X is also greater than the width of each of the stubs 53A-1 and 53A-2. This structure makes it possible to further improve isolation characteristics between the first radiation electrode 3 and the second radiation electrode 4.

### 1.2.2 Effects, Etc.

The antenna substrate 1A described above includes the baseplate 2, the planar-shaped first radiation electrode 3 that is disposed on the baseplate 2, the second radiation electrode 4 that is disposed on the baseplate 2 so as to be spatially apart from the first radiation electrode 3 in the second direction X when seen from the first direction Z along the thickness direction of the baseplate 2, and the ground portion 5A that is disposed on the baseplate 2 and that is common to the first radiation electrode 3 and the second radiation electrode 4. The ground portion 5A includes the ground electrode 51 that faces the first radiation electrode 3 when seen from the first direction Z, the connection line 52 that exists between the first radiation electrode 3 and the second radiation electrode 4 when seen from the first direction Z and that has a size that is smaller than the size of the ground electrode 51 in the third direction Y orthogonal to the second direction X when seen from the first direction Z, and the stubs 53A that are each connected to one of the first side 52a and the second side 52b of the connection line 52 that face each other in the third direction Y. This structure makes it possible to improve isolation characteristics between the first radiation electrode 3 and the second radiation electrode 4.

### 1.3 Third Embodiment

### 1.3.1 Structure

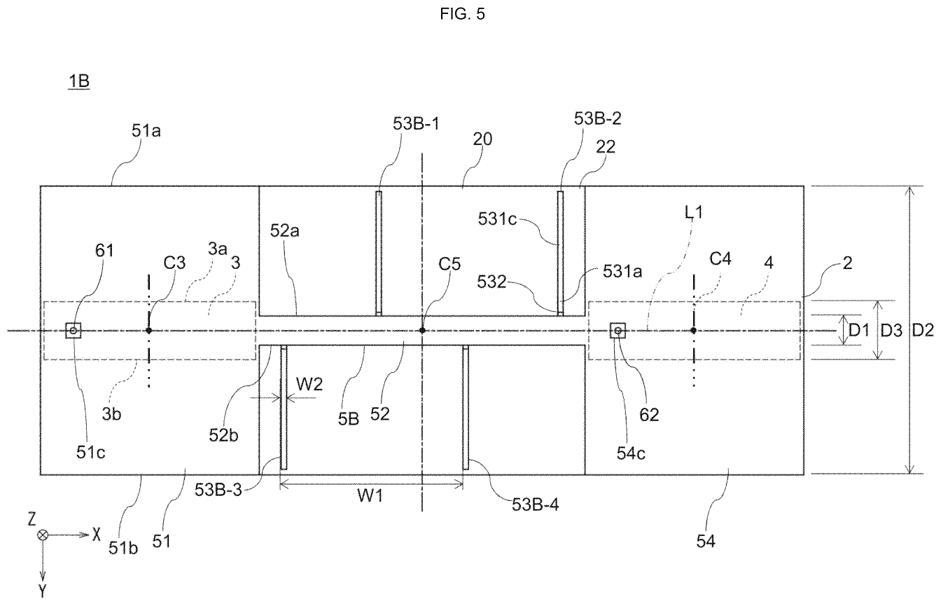

FIG. 5 is a bottom view of an example of a structure of an antenna substrate 1B according to a third embodiment. Instead of the antenna substrate 1, the antenna substrate 1B is used in an antenna module 10. The antenna substrate 1B includes a baseplate 2, a first radiation electrode 3, a second radiation electrode 4, a ground portion 5B, a first feed point 61, and a second feed point 62.

The ground portion 5B includes a first ground electrode 51, a connection line 52, and a plurality of stubs 53B-1 to 53B-4 (may be collectively denoted by reference numeral 53B below). Further, the ground portion 5B includes a second ground electrode 54 that differs from the first ground electrode 51.

The stubs 53B are each connected to one of a first side 52a and a second side 52b of the connection line 52 that face each other in the third direction Y.

First, the structure of each stub 53B is described. The stubs 53B-1, 53B-2, 53B-3, and 53B-4 have the same structure. Each stub 53B has a linear shape that is not bent. Each stub 53B includes a conductive path 531c and a chip component 532.

The conductive paths 531c are formed on the baseplate 2. The conductive paths 531c are conductive patterns that are formed on a second main surface 22 of a dielectric layer 20. More specifically, the conductive paths 531c each have a linear shape extending along the third direction Y.

In each of the stubs 53B-1 and 53B-2, the conductive path 531c extends in a direction opposite to the third direction Y from the first side 52a of the connection line 52. Each conductive path 531c is not directly connected to the connection line 52. In each of the stubs 53B-3 and 53B-4, the conductive path 531c extends in the third direction Y from the second side 52b of the connection line 52. Each conductive path 531c is not directly connected to the connection line 52.

Each chip component 532 is mounted on the baseplate 2. Each chip component 532 is mounted on the second main surface 22 of the dielectric layer 20. In the embodiment, each chip component 532 exists between a corresponding one of the conductive paths 531c and the connection line 52. That is, each chip component 532 is mounted on the baseplate 2 so as to connect a corresponding one of the conductive paths 531c and the connection line 52 to each other.

In each stub 53B, the conductive path 531c extends along the third direction Y. In FIG. 5, the stubs 53B do not fit within an inner side of the first ground electrode 51 in the third direction Y when seen from the second direction X. Therefore, when the electrical length of each stub 53B and the electrical length of each stub 53 are the same, the size of the baseplate 2 of the antenna substrate 1B in the third direction becomes larger than the size of the baseplate 2 of the antenna substrate 1 in the third direction. On the other hand, since each stub 53B has a linear shape and does not have a bent shape, the electrical characteristics thereof may be better than the electrical characteristics of each stub 53.

Next, the arrangement of the stubs 53B is described.

The stubs 53B-1 and 53B-2 are each connected to the first side 52a of the connection line 52, and the stubs 53B-3 and 53B-4 are each connected to the second side 52b of the connection line 52. The stubs 53B-1 and 53B-2 are first stubs, and the stubs 53B-3 and 53B-4 are second stubs. This structure makes it possible to improve electrical symmetry in the antenna substrate 1B and contributes to improving antenna characteristics and isolation characteristics between the first radiation electrode 3 and the second radiation electrode 4. The number of first stubs is two. The number of second stubs is two. The number of first stubs and the number of second stubs are equal to each other. This structure makes it possible to improve electrical symmetry in the antenna substrate 1B and contributes to improving antenna characteristics and isolation characteristics between the first radiation electrode 3 and the second radiation electrode 4.

First connection positions of one or more first stubs, that is, the first stubs 53B-1 and 53B-2, with the connection line 52 and second connection positions of one or more second stubs, that is, the second stubs 53B-3 and 53B-4, with the connection line 52 differ from each other in the second direction X. This structure makes it possible to further improve isolation characteristics between the first radiation electrode 3 and the second radiation electrode 4. The first connection positions and the second connection positions are in a point-symmetrical relationship with respect to a center C5 of the connection line 52 when seen from the first direction Z. This structure makes it possible to further improve isolation characteristics between the first radiation electrode 3 and the second radiation electrode 4.

Two or more stubs, that is, the stubs 53B-1 and 53B-2, of the four stubs 53B-1 to 53B-4, are connected to the same side (the first side 52a) of the connection line 52 and are disposed side by side along the second direction X. This structure makes it possible to further improve isolation characteristics between the first radiation electrode 3 and the second radiation electrode 4. The remaining two or more stubs, that is, the stubs 53B-3 and 53B-4, of the four stubs 53B-1 to 53B-4 are connected to a different side (the second side 52b) of the connection line 52 and are disposed side by side along the second direction X. This structure makes it possible to further improve isolation characteristics between the first radiation electrode 3 and the second radiation electrode 4.

An interval W1 between two or more stubs 53B in the second direction X is greater than a width W2 of each of the two or more stubs 53B. In FIG. 5, the interval W1 between the stubs 53B-3 and 53B-4 in the second direction X is greater than the width W2 of each of the stubs 53B-3 and 53B-4. Here, the width W2 of each of the stubs 53B-3 and 53B-4 is the width of a corresponding one of the conductive paths 531c. Although not shown clearly in FIG. 5, the interval between the stubs 53B-1 and 53B-2 in the second direction X is also greater than the width of each of the stubs 53B-1 and 53B-2. This structure makes it possible to further improve isolation characteristics between the first radiation electrode 3 and the second radiation electrode 4.

### 1.3.2 Effects, Etc.

The antenna substrate 1B described above includes the baseplate 2, the planar-shaped first radiation electrode 3 that is disposed on the baseplate 2, the second radiation electrode 4 that is disposed on the baseplate 2 so as to be spatially apart from the first radiation electrode 3 in the second direction X when seen from the first direction Z along the thickness direction of the baseplate 2, and the ground portion 5B that is disposed on the baseplate 2 and that is common to the first radiation electrode 3 and the second radiation electrode 4. The ground portion 5B includes the ground electrode 51 that faces the first radiation electrode 3 when seen from the first direction Z, the connection line 52 that exists between the first radiation electrode 3 and the second radiation electrode 4 when seen from the first direction Z and that has a size that is smaller than the size of the ground electrode 51 in the third direction Y orthogonal to the second direction X when seen from the first direction Z, and the stubs 53B that are each connected to one of the first side 52a and the second side 52b of the connection line 52 that face each other in the third direction Y. This structure makes it possible to improve isolation characteristics between the first radiation electrode 3 and the second radiation electrode 4.

### 1.4 Fourth Embodiment

### 1.4.1 Structure

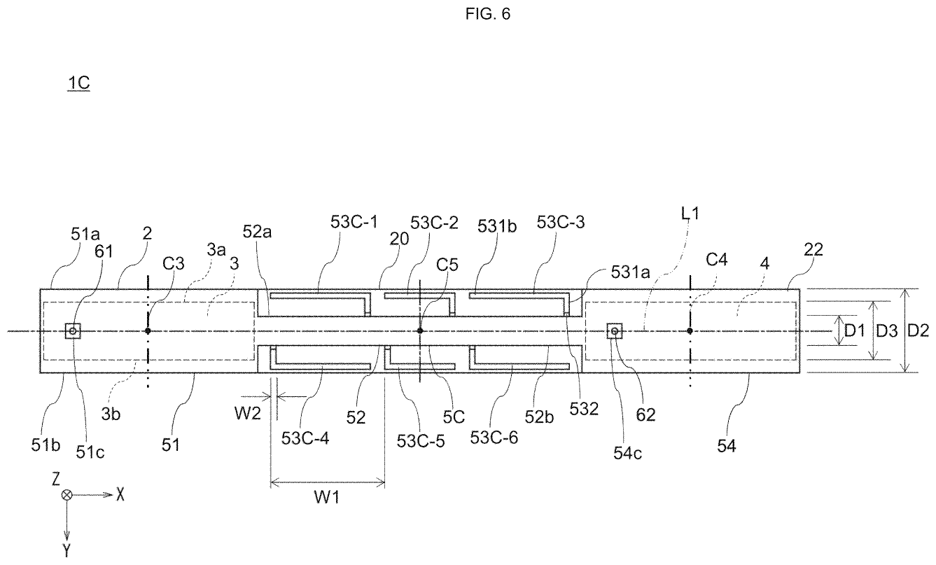

FIG. 6 is a bottom view of an example of a structure of an antenna substrate 1C according to a fourth embodiment. Instead of the antenna substrate 1, the antenna substrate 1C is used in an antenna module 10. The antenna substrate 1C includes a baseplate 2, a first radiation electrode 3, a second radiation electrode 4, a ground portion 5C, a first feed point 61, and a second feed point 62.

The ground portion 5C includes a first ground electrode 51, a connection line 52, and a plurality of stubs 53C-1 to 53C-6 (may be collectively denoted by reference numeral 53C below). Further, the ground portion 5B includes a second ground electrode 54 that differs from the first ground electrode 51.

The stubs 53C are each connected to one of a first side 52a and a second side 52b of the connection line 52 that face each other in the third direction Y.

First, the structure of each stub 53C is described. The stubs 53C-1, 53C-2, 53C-3, 53C-4, 53C-5, and 53C-6 have the same structure. Each stub 53C has a bent shape. In particular, each stub 53C has an L shape when seen from the first direction Z. Similarly to the stubs 53 in FIG. 3, each stub 53C includes conductive paths 531a and 531b and a chip component 532.

Two or more of two or more stubs 53C have electrical lengths that differ from each other. This structure makes it possible to, in a wider frequency band, improve isolation characteristics between the first radiation electrode 3 and the second radiation electrode 4. The stubs 53C-1, 53C-3, 53C-4, and 53C-6 have electrical lengths that differ from the electrical lengths of the stubs 53C-2 and 53C-5. The electrical lengths of the stubs 53C-1, 53C-3, 53C-4, and 53C-6 are the same as the electrical lengths of the stubs 53 of the antenna substrate 1. The antenna substrate 1C is capable of attenuating a high-frequency signal at the connection line 52 near the resonant frequencies of the stubs 53C-2 and 53C-5 that differ from those of the stubs 53. Therefore, compared to the antenna substrate 1, the antenna substrate 1C makes it possible to, in a wider frequency band, improve isolation characteristics between the first radiation electrode 3 and the second radiation electrode 4.

Next, the arrangement of the stubs 53C is described.

The stubs 53C-1, 53C-2, and 53C-3 are each connected to the first side 52a of the connection line 52, and the stubs 53C-4, 53C-5, and 53C-6 are each connected to the second side 52b of the connection line 52. The stubs 53C-1, 53C-2, and 53C-3 are first stubs, and the stubs 53C-4, 53C-5, and 53C-6 are second stubs. This structure makes it possible to improve electrical symmetry in the antenna substrate 1C and contributes to improving antenna characteristics and isolation characteristics between the first radiation electrode 3 and the second radiation electrode 4. The number of first stubs is three. The number of second stubs is three. The number of first stubs and the number of second stubs are equal to each other. This structure makes it possible to improve electrical symmetry in the antenna substrate 1C and contributes to improving antenna characteristics and isolation characteristics between the first radiation electrode 3 and the second radiation electrode 4.

First connection positions of one or more first stubs, that is, the first stubs 53C-1, 53C-2, and 53C-3, with the connection line 52 and second connection positions of one or more second stubs, that is, the second stubs 53C-4, 53C-5, and 53C-6, with the connection line 52 differ from each other in the second direction X. This structure makes it possible to further improve isolation characteristics between the first radiation electrode 3 and the second radiation electrode 4. The first connection positions and the second connection positions are in a point-symmetrical relationship with respect to a center C5 of the connection line 52 when seen from the first direction Z. This structure makes it possible to further improve isolation characteristics between the first radiation electrode 3 and the second radiation electrode 4.

Two or more stubs, that is, the stubs 53C-1 to 53C-3, of the six stubs 53C-1 to 53C-6 are connected to the same side (the first side 52a) of the connection line 52 and are disposed side by side along the second direction X. This structure makes it possible to further improve isolation characteristics between the first radiation electrode 3 and the second radiation electrode 4. The remaining two or more stubs, that is, the stubs 53C-4 to 53C-6, of the six stubs 53C-1 to 53C-6 are connected to a different side (the second side 52b) of the connection line 52 and are disposed side by side along the second direction X. This structure makes it possible to further improve isolation characteristics between the first radiation electrode 3 and the second radiation electrode 4.

An interval W1 between two or more stubs 53C in the second direction X is greater than a width W2 of each of the two or more stubs 53C. The interval W1 between the stubs 53C-4 and 53C-5 in the second direction X is greater than the width W2 of each of the stubs 53C-4 and 53C-5. Here, the width W2 of each of the stubs 53C-4 and 53C-5 is the width of a corresponding one of the conductive paths 531a. The width of each conductive path 531a may be equal to the width of a corresponding one of the conductive paths 531b. Although not shown clearly in FIG. 6, the interval between the other stubs 53C in the second direction X is also greater than the width of each of the stubs 53C. This structure makes it possible to further improve isolation characteristics between the first radiation electrode 3 and the second radiation electrode 4.

### 1.4.2 Effects, Etc.

The antenna substrate 1C described above includes the baseplate 2, the planar-shaped first radiation electrode 3 that is disposed on the baseplate 2, the second radiation electrode 4 that is disposed on the baseplate 2 so as to be spatially apart from the first radiation electrode 3 in the second direction X when seen from the first direction Z along the thickness direction of the baseplate 2, and the ground portion 5C that is disposed on the baseplate 2 and that is common to the first radiation electrode 3 and the second radiation electrode 4. The ground portion 5C includes the ground electrode 51 that faces the first radiation electrode 3 when seen from the first direction Z, the connection line 52 that exists between the first radiation electrode 3 and the second radiation electrode 4 when seen from the first direction Z and that has a size that is smaller than the size of the ground electrode 51 in the third direction Y orthogonal to the second direction X when seen from the first direction Z, and the stubs 53C that are each connected to one of the first side 52a and the second side 52b of the connection line 52 that face each other in the third direction Y. This structure makes it possible to improve isolation characteristics between the first radiation electrode 3 and the second radiation electrode 4.

In the antenna substrate 1C, two or more of two or more stubs 53C have electrical lengths that differ from each other. This structure makes it possible to, in a wider frequency band, improve isolation characteristics between the first radiation electrode 3 and the second radiation electrode 4.

### 1.5 Fifth Embodiment

### 1.5.1 Structure

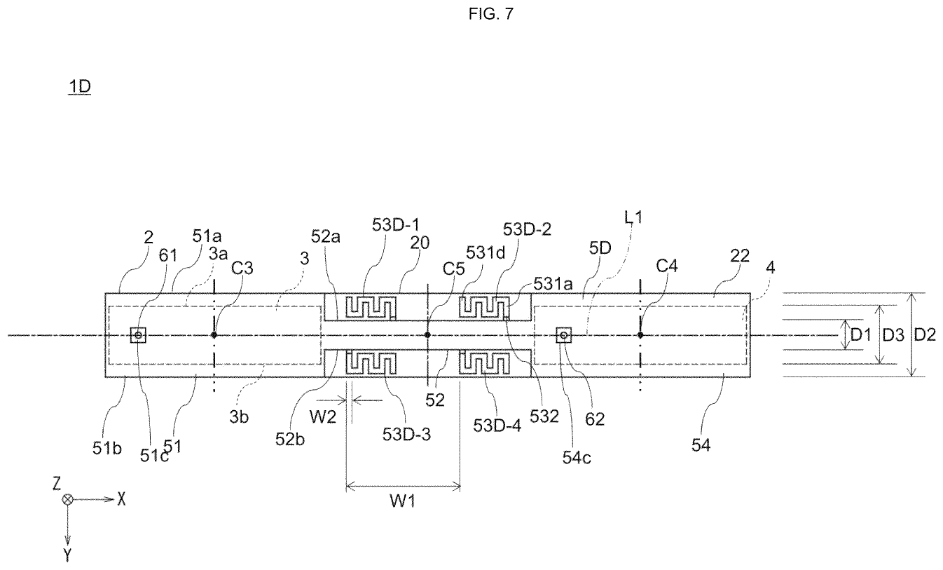

FIG. 7 is a bottom view of an example of a structure of an antenna substrate 1D according to a fifth embodiment. Instead of the antenna substrate 1, the antenna substrate 1D is used in an antenna module 10. The antenna substrate 1D includes a baseplate 2, a first radiation electrode 3, a second radiation electrode 4, a ground portion 5D, a first feed point 61, and a second feed point 62.

The ground portion 5D includes a ground electrode 51, a connection line 52, and a plurality of stubs 53D-1 to 53D-4 (may be collectively denoted by reference numeral 53D below). Further, the ground portion 5D includes a second ground electrode 54 that differs from the first ground electrode 51.

The stubs 53D are each connected to one of a first side 52a and a second side 52b of the connection line 52 that face each other in the third direction Y.

First, the structure of each stub 53D is described. The stubs 53D-1, 53D-2, 53D-3, and 53D-4 have the same structure. Each stub 53D has a bent shape. Each stub 53D includes conductive paths 531a and 531d and a chip component 532.

The conductive paths 531a and 531d are formed on the baseplate 2. The conductive paths 531a and 531d are conductive patterns that are formed on a second main surface 22 of a dielectric layer 20. More specifically, each conductive path 531a extends along the third direction Y from the connection line 52. Each conductive path 531a extends along the second direction X from an end of a corresponding one of the conductive paths 531d. The conductive paths 531a each have a linear shape. The conductive paths 531d each have a shape that is bent one or more times. The conductive paths 531d each have a meandering shape with respect to the second direction X. In each of the stubs 53D-1 and 53D-2, the conductive path 531a extends in a direction opposite to the third direction Y from the first side 52a of the connection line 52. Each conductive path 531a is not directly connected to the connection line 52. In each of the stubs 53D-1 and 53D-2, the conductive path 531d extends in a direction opposite to the second direction X from an end (upper end in FIG. 7) of a corresponding one of the conductive paths 531a. In each of the stubs 53D-3 and 53D-4, the conductive path 531a extends in the third direction Y from the second side 52b of the connection line 52. Each conductive path 531a is not directly connected to the connection line 52. Each conductive path 531d extends in the second direction X from an end (lower end in FIG. 7) of a corresponding one of the conductive paths 531a.

A physical length of each of the conductive paths 531a and 531d is set as appropriate in accordance with a target electrical length of each stub 53D. The physical length of each conductive path 531a is less than a physical length of each conductive path 531d. In particular, the physical length of each conductive path 531a is set such that the stubs 53D fit within an inner side of the first ground electrode 51 in the third direction Y when seen from the second direction X. This structure makes it possible to reduce the size of the baseplate 2 in the third direction Y. Similarly to the conductive paths 531b in FIG. 3, each conductive path 531d extends along the second direction X, but unlike the linear conductive paths 531b, each conductive path 531d has a shape that is bent one or more times. Therefore, when the conductive paths 531d in FIG. 7 and the conductive paths 531b in FIG. 3 have the same physical lengths, the length of each conductive path 531d in the second direction X can be less than the length of each conductive path 531b in FIG. 3 in the second direction X. Consequently, this structure makes it possible to decrease a maximum value of a length of a side of a region required to dispose the stubs 53D.

Each conductive path 531d extends along the second direction X. That is, at least part of each stub 53D extends along the second direction X. Capacitance can be produced between the connection line 52 and a portion (a portion of each conductive path 531d on a side of the connection line 52) of each stub 53D extending along the second direction X. Therefore, this structure makes it possible to decrease the electrical length of each stub 53D required to set the resonant frequency of each stub 53D to a target resonant frequency.

Each chip component 532 is mounted on the baseplate 2. Each chip component 532 is mounted on the second main surface 22 of the dielectric layer 20. In the embodiment, each chip component 532 exists between a corresponding one of the conductive paths 531a and the connection line 52.

Next, the arrangement of the stubs 53D is described.

The stubs 53D-1 and 53D-2 are each connected to the first side 52a of the connection line 52, and the stubs 53D-3 and 53D-4 are each connected to the second side 52b of the connection line 52. The stubs 53D-1 and 53D-2 are first stubs, and the stubs 53D-3 and 53D-4 are second stubs. This structure makes it possible to improve electrical symmetry in the antenna substrate 1D and contributes to improving antenna characteristics and isolation characteristics between the first radiation electrode 3 and the second radiation electrode 4. The number of first stubs is two. The number of second stubs is two. The number of first stubs and the number of second stubs are equal to each other. This structure makes it possible to improve electrical symmetry in the antenna substrate 1D and contributes to improving antenna characteristics and isolation characteristics between the first radiation electrode 3 and the second radiation electrode 4.

First connection positions of one or more first stubs, that is, the first stubs 53D-1 and 53D-2, with the connection line 52 and second connection positions of one or more second stubs, that is, the second stubs 53D-3 and 53D-4, with the connection line 52 differ from each other in the second direction X. This structure makes it possible to further improve isolation characteristics between the first radiation electrode 3 and the second radiation electrode 4. The first connection positions and the second connection positions are in a point-symmetrical relationship with respect to a center C5 of the connection line 52 when seen from the first direction Z. This structure makes it possible to further improve isolation characteristics between the first radiation electrode 3 and the second radiation electrode 4.

Two or more stubs, that is, the stubs 53D-1 and 53D-2, of the four stubs 53D-1 to 53D-4 are connected to the same side (the first side 52a) of the connection line 52 and are disposed side by side along the second direction X. This structure makes it possible to further improve isolation characteristics between the first radiation electrode 3 and the second radiation electrode 4. The remaining two or more stubs, that is, the stubs 53D-3 and 53D-4, of the four stubs 53D-1 to 53D-4 are connected to a different side (the second side 52b) of the connection line 52 and are disposed side by side along the second direction X. This structure makes it possible to further improve isolation characteristics between the first radiation electrode 3 and the second radiation electrode 4.

An interval W1 between two or more stubs 53D in the second direction X is greater than a width W2 of each of the two or more stubs 53D. In FIG. 7, the interval W1 between the stubs 53D-3 and 53D-4 in the second direction X is greater than the width W2 of each of the stubs 53D-3 and 53D-4. Here, the width W2 of each of the stubs 53D-3 and 53D-4 is the width of a corresponding one of the conductive paths 531d. Although not shown clearly in FIG. 7, the interval between the other stubs 53D in the second direction X is also greater than the width of each of the stubs 53D. This structure makes it possible to further improve isolation characteristics between the first radiation electrode 3 and the second radiation electrode 4.

### 1.5.2 Effects, Etc.

The antenna substrate 1D described above includes the baseplate 2, the planar-shaped first radiation electrode 3 that is disposed on the baseplate 2, the second radiation electrode 4 that is disposed on the baseplate 2 so as to be spatially apart from the first radiation electrode 3 in the second direction X when seen from the first direction Z along the thickness direction of the baseplate 2, and the ground portion 5D that is disposed on the baseplate 2 and that is common to the first radiation electrode 3 and the second radiation electrode 4. The ground portion 5D includes the ground electrode 51 that faces the first radiation electrode 3 when seen from the first direction Z, the connection line 52 that exists between the first radiation electrode 3 and the second radiation electrode 4 when seen from the first direction Z and that has a size that is smaller than the size of the ground electrode 51 in the third direction Y orthogonal to the second direction X when seen from the first direction Z, and the stubs 53D that are each connected to one of the first side 52a and the second side 52b of the connection line 52 that face each other in the third direction. This structure makes it possible to improve isolation characteristics between the first radiation electrode 3 and the second radiation electrode 4.

In the antenna substrate 1D, each stub 53D has a shape that is bent two or more times. This structure makes it possible to decrease a maximum value of a length of a side of a region required to dispose the stubs 53D.

### 1.6 Sixth Embodiment

### 1.6.1 Structure

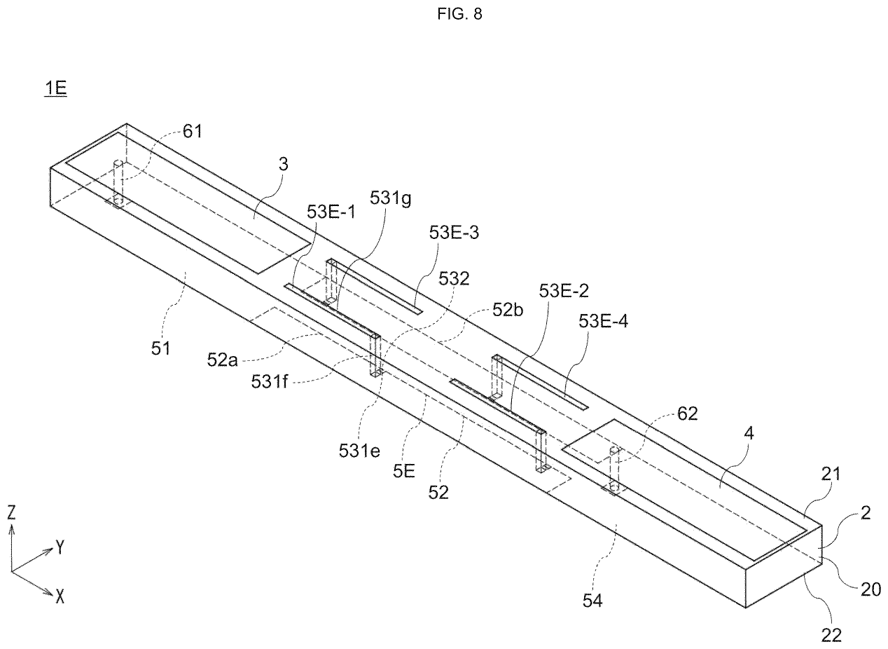

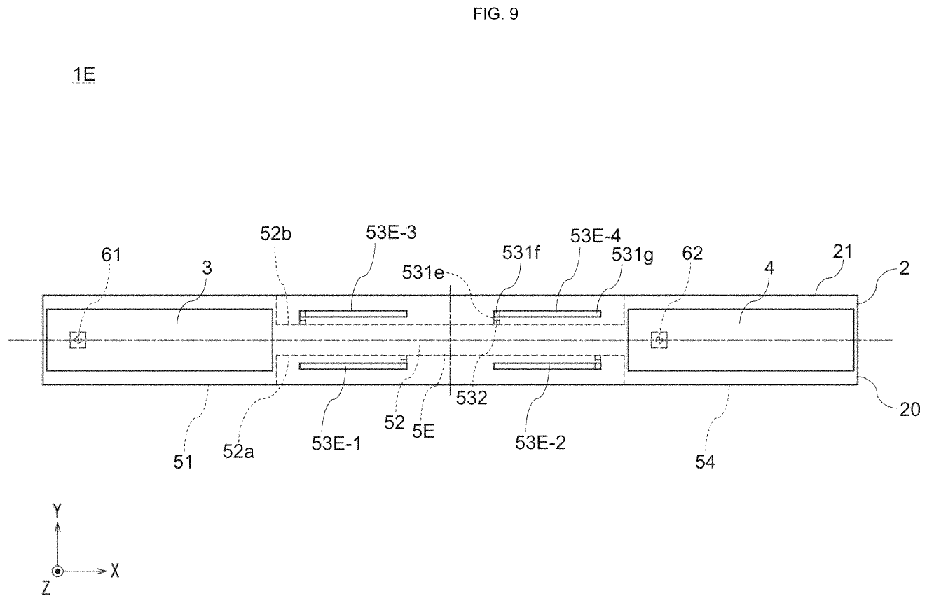

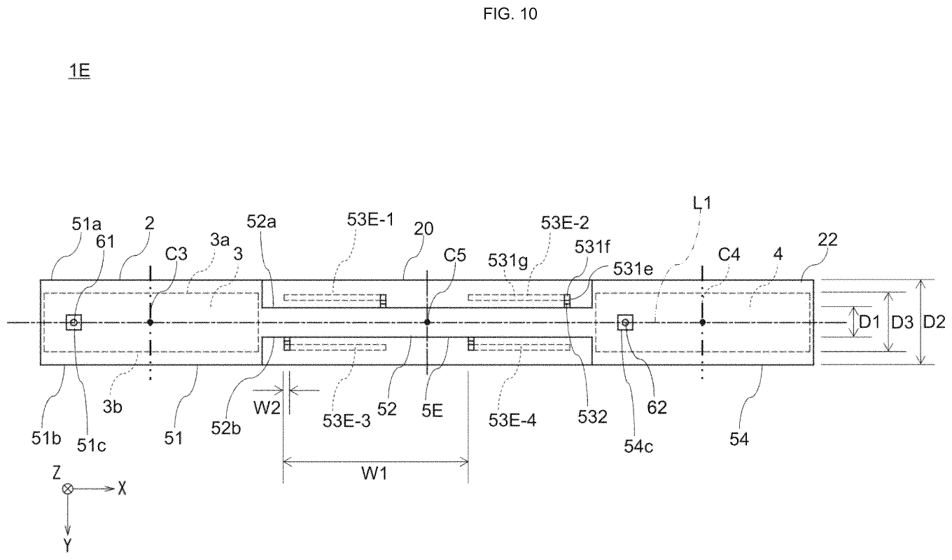

FIG. 8 is a perspective view of an example of a structure of an antenna substrate 1E according to a sixth embodiment. FIG. 9 is a plan view of the antenna substrate 1E. FIG. 10 is a bottom view of the antenna substrate 1E. Instead of the antenna substrate 1, the antenna substrate 1E is used in an antenna module 10.

As shown in FIGS. 8, 9, and 10, the antenna substrate 1E includes a baseplate 2, a first radiation electrode 3, a second radiation electrode 4, a ground portion 5E, a first feed point 61, and a second feed point 62.

As shown in FIGS. 8 to 10, the ground portion 5E is provided on the baseplate 2. The ground portion 5E includes a first ground electrode 51, a connection line 52, and a plurality of stubs 53E-1 to 53E-4 (may be collectively denoted by reference numeral 53E below). Further, the ground portion 5E includes a second ground electrode 54 that differs from the first ground electrode 51.

The stubs 53E are each connected to one of a first side 52a and a second side 52b of the connection line 52 that face each other in the third direction.

First, the structure of each stub 53E is described. The stubs 53E-1, 53E-2, 53E-3, and 53E-4 have the same structure. Each stub 53E has a bent shape. In particular, each stub 53E has an L shape when seen from the second direction X, and has an L shape when seen from the third direction Y. Each stub 53E includes conductive paths 531e, 531f, and 531g, and a chip component 532.

The conductive paths 531e, 531f, and 531g are formed on the baseplate 2. As shown in FIGS. 8 and 10, the conductive paths 531e are conductive patterns that are formed on a second main surface 22 of a dielectric layer 20. More specifically, each conductive path 531e extends along the third direction Y from the connection line 52. The conductive paths 531e each have a linear shape. As shown in FIG. 8, each conductive path 531f is a through-hole wire that extends through the dielectric layer 20 of the baseplate 2. Each conductive path 531f is such that each conductive path 531f extends along a direction that intersects a plane including the second direction X and the third direction Y from an end of a corresponding one of the conductive paths 531e. In the embodiment, each conductive path 531f extends along the first direction Z. A first end of each first conductive path 531f is exposed at a first main surface 21 of the dielectric layer 20 and is connected to a corresponding one of the conductive paths 531g, and a second end of each conductive path 531f is exposed at the second main surface 22 of the dielectric layer 20 and is connected to a corresponding one of the conductive paths 531e. As shown in FIGS. 8 and 9, the conductive paths 531g are conductive patterns that are formed on the first main surface 21 of the dielectric layer 20. More specifically, each conductive path 531g extends along the second direction X from the first end of a corresponding one of the conductive paths 531f. The conductive paths 531g each have a linear shape.

In each of the stubs 53E-1 and 53E-2, the conductive path 531e extends in a direction opposite to the third direction Y from the first side 52a of the connection line 52. Each conductive path 531e is not directly connected to the connection line 52. In each of the stubs 53E-1 and 53E-2, the conductive path 531f extends in the first direction Z from an end (upper end in FIG. 10) of a corresponding one of the conductive paths 531e. In each of the stubs 53E-1 and 53E-2, the conductive path 531g extends in a direction opposite to the second direction X from the first end of a corresponding one of the conductive paths 531f. In each of the stubs 53E-3 and 53E-4, the conductive path 531e extends in the third direction Y from the first end 52a of the connection line 52. Each conductive path 531e is not directly connected to the connection line 52. In each of the stubs 53E-3 and 53E-4, the conductive path 531f extends in the first direction Z from an end (lower end in FIG. 10) of a corresponding one of the conductive paths 531e. In each of the stubs 53E-3 and 53E-4, the conductive path 531g extends in the second direction X from the first end of a corresponding one of the conductive paths 531f.

A physical length of each of the conductive paths 531e, 531f, and 531g is set as appropriate in accordance with a target electrical length of each stub 53E. Each conductive path 531f extends along a direction (in the embodiment, the first direction Z) that intersects a plane including the second direction X and the third direction Y. That is, at least part of each stub 53E extends along the direction (in the embodiment, the first direction Z) that intersects the plane including the second direction X and the third direction Y. Therefore, in the plane including the second direction X and the third direction Y, that is, when seen from the first direction Z, it is possible to reduce the size of a region required to dispose the stubs 53E.

The physical length of each conductive path 531e is less than the physical length of each conductive path 531f and the physical length of each conductive path 531g. In particular, in the embodiment, the physical length of each conductive path 531e is set such that the stubs 53E fit within an inner side of the first radiation electrode 3 in the third direction Y when seen from the second direction X. More specifically, in the third direction Y, the stubs 53E-1 and 53E-2 fit between a side (the first side 52a) of the connection line 52 to which the stubs 53E-1 and 53E-2 are connected and a side (a first side 3a) of the first radiation electrode 3 that exists on the same side as the side (the first side 52a) of the connection line 52 to which the stubs 53E-1 and 53E-2 are connected. In the third direction Y, the stubs 53E-3 and 53E-4 fit between a side (the second side 52b) of the connection line 52 to which the stubs 53E-3 and 53E-4 are connected and a side (a second side 3b) of the first radiation electrode 3 that exists on the same side as the side (the second side 52b) of the connection line 52 to which the stubs 53E-3 and 53E-4 are connected. This structure makes it possible to reduce the size of the baseplate 2 in the third direction Y.

Each chip component 532 is mounted on the baseplate 2. In FIG. 10, each chip component 532 is mounted on the second main surface 22 of the dielectric layer 20. In the embodiment, each chip component 532 exists between a corresponding one of the conductive paths 531e and the connection line 52.

In each stub 53E, the conductive path 531g extends along the second direction X. That is, at least part of each stub 53E extends along the second direction X. This structure makes it possible to decrease the electrical length of each stub 53E required to set the resonant frequency of each stub 53E to a target resonant frequency.

Next, the arrangement of the stubs 53E is described.

The stubs 53E-1 and 53E-2 are each connected to the first side 52a of the connection line 52, and the stubs 53E-3 and 53E-4 are each connected to the second side 52b of the connection line 52. In FIG. 10, the stubs 53E-1 and 53E-2 are first stubs, and the stubs 53E-3 and 53E-4 are second stubs. This structure makes it possible to improve electrical symmetry in the antenna substrate 1E and contributes to improving antenna characteristics and isolation characteristics between the first radiation electrode 3 and the second radiation electrode 4. The number of first stubs is two. The number of second stubs is two. The number of first stubs and the number of second stubs are equal to each other. This structure makes it possible to improve electrical symmetry in the antenna substrate 1E and contributes to improving antenna characteristics and isolation characteristics between the first radiation electrode 3 and the second radiation electrode 4.

First connection positions of one or more first stubs, that is, the first stubs 53E-1 and 53E-2, with the connection line 52 and second connection positions of one or more second stubs, that is, the second stubs 53E-3 and 53E-4, with the connection line 52 differ from each other in the second direction X. This structure makes it possible to further improve isolation characteristics between the first radiation electrode 3 and the second radiation electrode 4. The first connection positions and the second connection positions are in a point-symmetrical relationship with respect to a center C5 of the connection line 52 when seen from the first direction Z. This structure makes it possible to further improve isolation characteristics between the first radiation electrode 3 and the second radiation electrode 4.

Two or more stubs, that is, the stubs 53E-1 and 53E-2, of the four stubs 53E-1 to 53E-4 are connected to the same side (the first side 52a) of the connection line 52 and are disposed side by side along the second direction X. This structure makes it possible to further improve isolation characteristics between the first radiation electrode 3 and the second radiation electrode 4. The remaining two or more stubs, that is, the stubs 53E-3 and 53E-4, of the four stubs 53E-1 to 53E-4 are connected to a different side (the second side 52b) of the connection line 52 and are disposed side by side along the second direction X. This structure makes it possible to further improve isolation characteristics between the first radiation electrode 3 and the second radiation electrode 4.

An interval W1 between two or more stubs 53E in the second direction X is greater than a width W2 of each of the two or more stubs 53E. In FIG. 10, the interval W1 between the stubs 53E-3 and 53E-4 in the second direction X is greater than the width W2 of each of the stubs 53E-3 and 53E-4. Here, the width W2 of each of the stubs 53E-3 and 53E-4 is the width of a corresponding one of the conductive paths 531e. The width of each conductive path 531e may be equal to the width of a corresponding one of the conductive paths 531f and a corresponding one of the conductive paths 531g. Although not shown clearly in FIG. 10, the interval between the stubs 53E-1 and 53E-2 in the second direction X is also greater than the width of each of the stubs 53E-1 and 53E-2. This structure makes it is possible to further improve isolation characteristics between the first radiation electrode 3 and the second radiation electrode 4.

### 1.6.2 Effects, Etc.

The antenna substrate 1E described above includes the baseplate 2, the planar-shaped first radiation electrode 3 that is disposed on the baseplate 2, the second radiation electrode 4 that is disposed on the baseplate 2 so as to be spatially apart from the first radiation electrode 3 in the second direction X when seen from the first direction Z along the thickness direction of the baseplate 2, and the ground portion 5E that is disposed on the baseplate 2 and that is common to the first radiation electrode 3 and the second radiation electrode 4. The ground portion 5E includes the ground electrode 51 that faces the first radiation electrode 3 when seen from the first direction Z, the connection line 52 that exists between the first radiation electrode 3 and the second radiation electrode 4 when seen from the first direction Z and that has a size that is smaller than the size of the ground electrode 51 in the third direction Y orthogonal to the second direction X when seen from the first direction Z, and the stubs 53E that are each connected to one of the first side 52a and the second side 52b of the connection line 52 that face each other in the third direction Y. This structure makes it possible to improve isolation characteristics between the first radiation electrode 3 and the second radiation electrode 4.

In the antenna substrate 1E, at least part (conductive path 531f) of each stub 53E extends along the direction that intersects the plane including the second direction X and the third direction Y. This structure makes it possible to reduce the size of the baseplate 2 in the third direction Y.

In the antenna substrate 1E, in the third direction Y, the stubs 53E fit between sides (the first side 52a, the second side 52b) of the connection line 52 to which the stubs 53E are connected and sides (the first side 3a, the second side 3b) of the first radiation electrode 3 that exists on the same side as the sides (the first side 52a, the second side 52b) of the connection line 52 to which the stubs 53E are connected. This structure makes it possible to reduce the size of the baseplate 2 in the third direction Y.

### 1.7 Seventh Embodiment

### 1.7.1 Structure

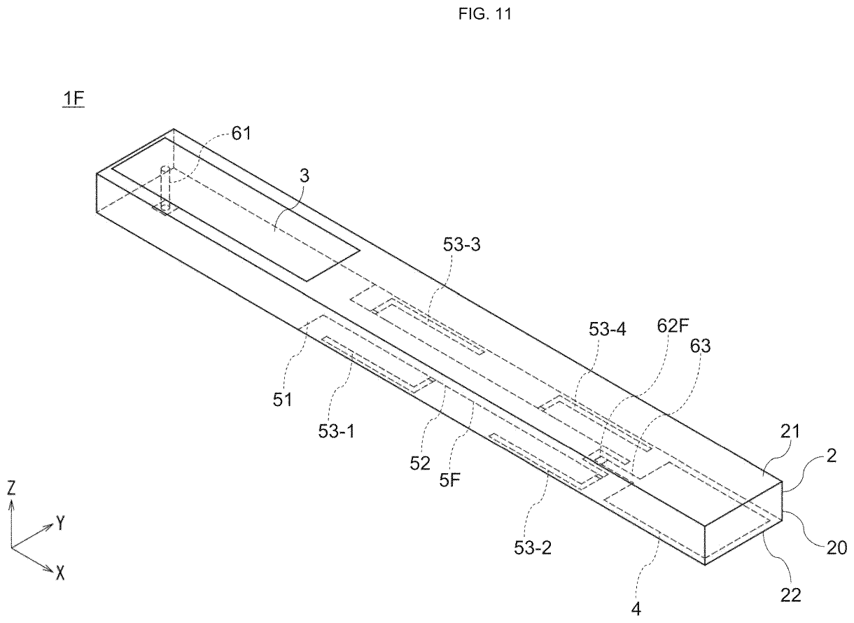

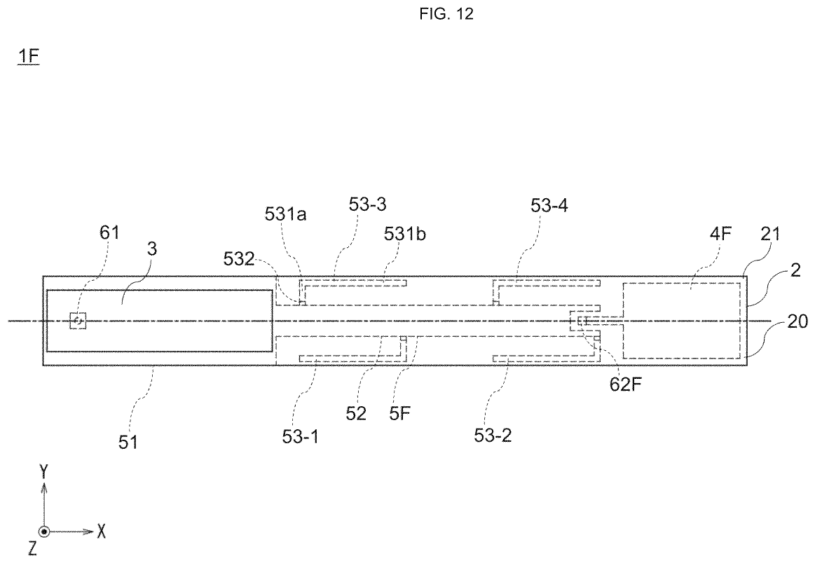

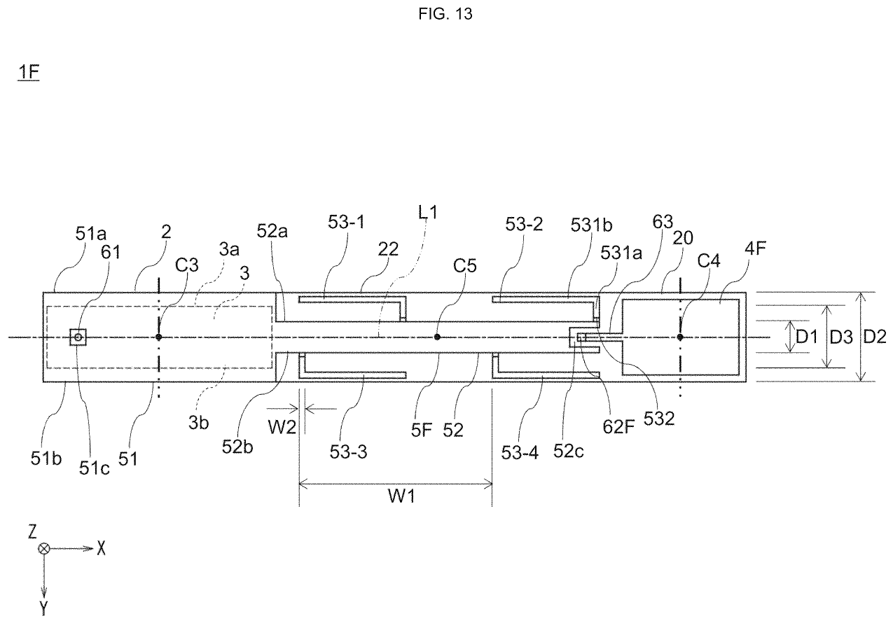

FIG. 11 is a perspective view of an example of a structure of an antenna substrate 1F according to a seventh embodiment. FIG. 12 is a plan view of the antenna substrate 1F. FIG. 13 is a bottom view of the antenna substrate 1F. Instead of the antenna substrate 1, the antenna substrate 1F is used in an antenna module 10.

As shown in FIGS. 11, 12, and 13, the antenna substrate 1F includes a baseplate 2, a first radiation electrode 3, a second radiation electrode 4F, a ground portion 5F, a first feed point 61, a second feed point 62F, and a feed path 63.

As shown in FIGS. 11 to 13, the first radiation electrode 3 and the second radiation electrode 4F are positioned on different surfaces of the baseplate 2. More specifically, the first radiation electrode 3 is positioned on a first main surface 21 of a dielectric layer 20 of the baseplate 2. The second radiation electrode 4F is positioned on a second main surface 22 of the dielectric layer 20 of the baseplate 2. Although the first radiation electrode 3 and the second radiation electrode 4F are positioned on the different surfaces of the baseplate 2, the first radiation electrode 3 and the second radiation electrode 4F are disposed side by side and apart from each other in the second direction X. When seen from the first direction Z, the second radiation electrode 4F is disposed on the baseplate 2 so as to be spatially apart from the first radiation electrode 3 in the second direction X. The second radiation electrode 4F exists on a side opposite to the first radiation electrode 3 with respect to a connection line 52F so as not to face the ground portion 5F when seen from the first direction Z. The first radiation electrode 3 and the second radiation electrode 4F exist on a corresponding one of two ends of the dielectric layer 20 of the baseplate 2 in the second direction X. As described above, the second direction X is the length direction of the baseplate 2, and the third direction Y is the width direction of the baseplate 2. This structure makes it possible to reduce the size of the baseplate 2.

The second radiation electrode 4F is a conductive pattern that is formed on the second main surface 22 of the dielectric layer 20. The second radiation electrode 4F has a planar shape. The second radiation electrode 4F has a substantially rectangular shape when seen from the first direction Z. As shown in FIG. 13, when seen from the first direction Z, the second radiation electrode 4F is line-symmetrical with respect to a line that extends through a center C4 of the second radiation electrode 4F and that is parallel to the second direction X. When seen from the first direction Z, a center C3 of the first radiation electrode 3 and the center C4 of the second radiation electrode 4F are disposed side by side along the second direction X. That is, a straight line that connects the center C3 of the first radiation electrode 3 and the center C4 of the second radiation electrode 4F is parallel to the second direction X.

The shape of the first radiation electrode 3 and the shape of the second radiation electrode 4F are determined in accordance with a frequency band that is used in radio communication. The first radiation electrode 3 and the second radiation electrode 4F have different shapes.

The second feed point 62F is a feed point of the second radiation electrode 4F. The second feed point 62F is used to supply a high-frequency signal to the second radiation electrode 4F. As an example, an inner conductor of a coaxial cable is connected to the second radiation electrode 4F through the second feed point 62F. As shown in FIG. 13, the second feed point 62F exists between the first radiation electrode 3 and the second radiation electrode 4F when seen from the first direction Z. Although schematically shown in FIGS. 11 to 13, the second feed point 62F is, for example, a through-hole wire that extends through a protective layer 23 (see FIG. 1) that covers the second main surface 22 of the dielectric layer 20 of the baseplate 2. The second feed point 62F is connected to the second radiation electrode 4F by the feed path 63. The feed path 63 is a conductive pattern that is formed on the second main surface 22 of the dielectric layer 20.

When seen from the first direction Z, the center C4 of the second radiation electrode 4F and the second feed point 62F (the feed point of the second radiation electrode 4F) are disposed side by side along the second direction X. This structure makes it possible to cause a direction in which the size of the second radiation electrode 4F is adjusted in accordance with the frequency band of radio communication that uses the second radiation electrode 4F to be the second direction X instead of the third direction Y. Therefore, this structure makes it possible to reduce the size of the baseplate 2 in the third direction Y. In the structure in which, when seen from the first direction Z, the center C4 of the second radiation electrode 4F and the second feed point 62F are disposed side by side along the second direction X, the feed path 63 extends along the second direction X.

As shown in FIG. 13, the ground portion 5F is positioned on the second main surface 22 of the dielectric layer 20 of the baseplate 2. The ground portion 5F is a ground portion that is common to the first radiation electrode 3 and the second radiation electrode 4F. In other words, the ground portion 5F is used as ground with respect to the first radiation electrode 3 and the second radiation electrode 4F.

The ground portion 5F in FIG. 13 includes a ground electrode 51, a connection line 52F, and a plurality of stubs 53-1 to 53-4 (may be collectively denoted by reference numeral 53 below).

The first ground electrode 51 faces the first radiation electrode 3 when seen from the first direction Z. In the antenna substrate 1F, the first radiation electrode 3 and the first ground electrode 51 constitute a planar antenna (patch antenna). The first ground electrode 51 is a conductive pattern that is formed on the second main surface 22 of the dielectric layer 20. The first ground electrode 51 has a planar shape. The first ground electrode 51 has a substantially rectangular shape when seen from the first direction Z. The size of the first ground electrode 51 is larger than the size of the first radiation electrode 3. When seen from the first direction Z, the first radiation electrode 3 fits within an inner side of the first ground electrode 51.

The connection line 52F exists between the first radiation electrode 3 and the second radiation electrode 4F when seen from the first direction Z. The connection line 52F is a conductive pattern that is formed on the second main surface 22 of the dielectric layer 20. The connection line 52F is connected to the first ground electrode 51. The connection line 52F is continuously integrally formed with the first ground electrode 51.

Although the connection line 52F extends toward the second radiation electrode 4F from the first ground electrode 51, the connection line 52F is not connected to the second radiation electrode 4F. In particular, when seen from the first direction Z, the second feed point 62F and the feed path 63 exist between the first radiation electrode 3 and the second radiation electrode 4F. Although the connection line 52F extends so as to be disposed closer to the second radiation electrode 4F than the second feed point 62F, a cutaway portion 52c is provided around the second feed point 62F at the second main surface 22 such that the connection line 52F is isolated from the second feed point 62F and the feed path 63.

The connection line 52F extends toward the second radiation electrode 4F from the first ground electrode 51, as a result of which the second radiation electrode 4F and the connection line 52F constitute a monopole antenna.

In the antenna substrate 1F, the first ground electrode 51, together with the first radiation electrode 3, constitutes a planar antenna (patch antenna), and the connection line 52F, together with the second radiation electrode 4F, constitutes a monopole antenna. The antenna substrate 1F includes different types of antennas. Therefore, the antenna substrate 1F is capable of radio emission in two different directions.

When seen from the first direction Z, the center C3 of the first radiation electrode 3 and a center C5 of the connection line 52F are disposed side by side along the second direction X. That is, a straight line Li that connects the center C3 of the first radiation electrode 3 and the center C5 of the connection line 52F is parallel to the second direction X. This structure makes it possible to further improve isolation characteristics between the first radiation electrode 3 and the second radiation electrode 4F.

The connection line 52F has a shape that is line-symmetrical with respect to a line that extends through the center C3 of the first radiation electrode 3 and that is parallel to the second direction X. This structure makes it possible to further improve isolation characteristics between the first radiation electrode 3 and the second radiation electrode 4F.

The size of the connection line 52F is smaller than the size of the first ground electrode 51 in the third direction Y. As shown in FIG. 13, a dimension D1 of the connection line 52F in the third direction Y is less than a dimension D2 of the first ground electrode 51 in the third direction Y. This structure makes it easier for electrical current to concentrate in the connection line 52 than in the first ground electrode 51.

The size of the connection line 52F is smaller than the size of the first radiation electrode 3 in the third direction Y. As shown in FIG. 13, the dimension D1 of the connection line 52F in the third direction Y is less than a dimension D3 of the first radiation electrode 3 in the third direction Y. This structure makes it possible to reduce the size of the baseplate 2 in the third direction Y.

The stubs 53 are each connected to one of a first side 52a and a second side 52b of the connection line 52F that face each other in the third direction Y. The ground portion 5F includes the plurality of stubs 53, that is, four stubs 53-1 to 53-4. The stubs 53 are provided for improving isolation characteristics between the first radiation electrode 3 and the second radiation electrode 4F. The structure of each stub 53 in FIG. 13 is the same as the structure of each stub 53 in FIG. 3.

### 1.7.2 Effects, Etc.

The antenna substrate 1F described above includes the baseplate 2, the planar-shaped first radiation electrode 3 that is disposed on the baseplate 2, the second radiation electrode 4F that is disposed on the baseplate 2 so as to be spatially apart from the first radiation electrode 3 in the second direction X when seen from the first direction Z along the thickness direction of the baseplate 2, and the ground portion 5F that is disposed on the baseplate 2 and that is common to the first radiation electrode 3 and the second radiation electrode 4F. The ground portion 5F includes the ground electrode 51 that faces the first radiation electrode 3 when seen from the first direction Z, the connection line 52 that exists between the first radiation electrode 3 and the second radiation electrode 4F when seen from the first direction Z and that has a size that is smaller than the size of the ground electrode 51F in the third direction Y orthogonal to the second direction X when seen from the first direction Z, and the stubs 53 that are each connected to one of the first side 52a and the second side 52b of the connection line 52 that face each other in the third direction Y. This structure makes it possible to improve isolation characteristics between the first radiation electrode 3 and the second radiation electrode 4F.

In the antenna substrate 1F, the second radiation electrode 4F exists on a side opposite to the first radiation electrode 3 with respect to the connection line 52F so as not to face the ground portion 5F in the first direction Z. This structure makes it possible to reduce the size of the baseplate 2.

### 2. Modifications

Embodiments of the disclosure are not limited to the embodiments above. The embodiments above can be variously modified in accordance with, for example, design, as long as the objects of the disclosure can be realized. Modifications of the embodiments above are given below. The modifications described below are applicable by being combined as appropriate.

Note that, in the description below, although, even when application can be made to any one of the first to seventh embodiments above, the reference signs used in the first embodiment are referred to, they are merely referred to for simplification and such use is not intended to exclude applicability to the second to seventh embodiments.

In one modification, the frequency band of radio communication that uses the first radiation electrode 3 or the second radiation electrode 4 is not particularly limited. For example, the frequency band may be selected from well-known frequency bands, such as a frequency band of radio communication using UWB, a Bluetooth (registered trademark) frequency band, a frequency band of radio communication using Wi-Fi, 2G (2nd Generation Mobile Communication) standard mid-band, 4G (4th Generation Mobile Communication) standard low band, and 5G (5th Generation Mobile Communication) standard low band. The 2G standard is, for example, a GSM (registered trademark) standard (GSM: Global System for Mobile Communications). The 4G standard is, for example, 3GPP (registered trademark) LTE standard (LTE: Long Term Evolution). The 5G standard is, for example, 5G NR (New Radio). The frequency band may be selected from frequency bands used in various communication standards, such as wireless LAN, Specified Low Power Radio, and near field communication.

In one modification, the shapes and dimensions of the first radiation electrode 3, the second radiation electrode 4, and the ground portion 5, in particular, the shapes and dimensions of the first ground electrode 51, the connection line 52, the stubs 53, and the second ground electrode 54 of the ground portion 5 may be changed as appropriate. As one example, the first radiation electrode 3, the second radiation electrode 4, the first ground electrode 51, the connection line 52, and the second ground electrode 54 need not be line-symmetrical. The arrangement of the stubs 53 with respect to the connection line 52 may be changed as appropriate.

In one modification, the number of stubs 53 is not particularly limited. The ground portion 5 is to include one or more stubs 53. The ground portion 5 may include a plurality of types of stubs 53 having different structures. For example, the ground portion 5 may include two or more types of stubs selected from the stubs 53, 53A, 53B, 53C, 53D, and 53E that have been described in the embodiments above. As one example, the ground portion 5 of the first embodiment may include the stubs 53E of the sixth embodiment in addition to the stubs 53.

In one modification, the structure of the baseplate 2 is not particularly limited. For example, the shape of the baseplate 2 is not limited to a rectangular plate shape. The baseplate 2 may have a well-known structure of, for example, a double-sided copper clad laminate or a multilayer baseplate. As one example, in the first embodiment, the baseplate 2 may include a plurality of dielectric layers, and the first radiation electrode 3, the second radiation electrode 4, and the ground portion 5 may be positioned at different dielectric layers. The baseplate 2 may include, in addition to the dielectric layers, for example, a protective layer for protecting the first radiation electrode 3, the second radiation electrode 4, or the ground portion 5.

In one modification, each stub 53 may include one or more conductive paths, that is, the conductive paths 531a and 531b, that are formed on the baseplate 2, and one or more chip components 532 that are mounted on the baseplate 2. The number of conductive paths 531a and 531b of each stub 53 is not particularly limited. The number of chip components 532 of each stub 53 is not particularly limited. Each chip component 532 may include at least one or more of an inductor, a capacitor, or a 0Ω resistor. As in the second embodiment, each stub 53A need not include a chip component 532.

In one modification, each stub 53 need not extend in a direction parallel to any one of the first direction Z, the second direction X, and the third direction Y. Each stub 53 may extend in a direction that intersects any one of the first direction Z, the second direction X, and the third direction Y.

In one modification, each stub 53D is to have a shape that is bent two or more times, and its shape is not limited to a meandering shape. Each stub 53D may have, for example, a U shape or a spiral shape.

In one modification, the structure of the first feed point 61 and the structures of the second feed points 62 and 62F are not particularly limited. As one example, although the first feed point 61 has a structure that is directly connected to the first radiation electrode 3, the first feed point 61 may have a structure that is coupled in a capacitive manner to the first radiation electrode 3 and that allows indirect power feeding. This point similarly also applies to the second feed points 62 and 62F.

In one modification, the antenna module 10 is not limited to the structure including the electronic components 11 and 12, and may include one or more electronic components. The electronic components are not limited to processing circuits or connectors.

### 3. Aspects

As is clear from the embodiments and modifications above, the disclosure includes the following aspects. In order to hereunder only make explicit correspondences between the embodiments above, the reference signs are added with parentheses. Note that, in order to make it easier to read the sentences, the reference signs with parentheses may be omitted from the second time onward.

A first aspect is an antenna substrate (1; 1A to 1F) that includes a baseplate (2), a first radiation electrode (3) that is disposed on the baseplate (2) and that has a planar shape, a second radiation electrode (4; 4F) that is disposed on the baseplate (2) so as to be spatially apart from the first radiation electrode (3) in a second direction (X) when seen from a first direction (Z) along a thickness direction of the baseplate (2), and a ground portion (5; 5A to 5F) that is disposed on the baseplate (2) and that is common to the first radiation electrode (3) and the second radiation electrode (4; 4F), in which the ground portion (5; 5A to 5F) includes a ground electrode (51) that faces the first radiation electrode (3) when seen from the first direction (Z), a connection line (52; 52F) that exists between the first radiation electrode (3) and the second radiation electrode (4; 4F) when seen from the first direction (Z) and that has a size that is smaller than a size of the ground electrode (51) in a third direction (Y) orthogonal to the second direction (X) when seen from the first direction (Z), and a stub (53; 53A; 53B; 53C; 53D; 53E) that is connected to one of a first side (52a) and a second side (52b) of the connection line (52; 52F) that face each other in the third direction (Y). This aspect makes it possible to improve isolation characteristics between the first radiation electrode (3) and the second radiation electrode (4; 4F).

A second aspect is an antenna substrate (1; 1A to 1F) based on the first aspect. In this aspect, the size of the connection line (52; 52F) is smaller than a size of the first radiation electrode (3) in the third direction (Y). This aspect makes it possible to reduce the size of the baseplate (2) in the third direction (Y).

A third aspect is an antenna substrate (1; 1A to 1F) based on the first aspect or the second aspect. In this aspect, the ground portion (5; 5A to 5F) includes a plurality of the stubs (53; 53A; 53B; 53C; 53D; 53E). The plurality of the stubs (53; 53A; 53B; 53C; 53D; 53E) include one or more first stubs (53-1, 53-2; 53A-1, 53A-2; 53B-1, 53B-2; 53C-1 to 53C-3; 53D-1, 53D-2; 53E-1, 53E-2) that are connected to the first side (52a) of the connection line (52; 52F), and one or more second stubs (53-3, 53-4; 53A-3, 53A-4; 53B-3, 53B-4; 53C-4 to 53C-6; 53D-3, 53D-4; 53E-3, 53E-4) that are connected to the second side (53b) of the connection line (52; 52F). This aspect makes it possible to improve electrical symmetry in the antenna substrate (1; 1A to 1F) and contributes to improving antenna characteristics and isolation characteristics between the first radiation electrode (3) and the second radiation electrode (4; 4F).

A fourth aspect is an antenna substrate (1; 1A to 1F) based on the third aspect. In this aspect, the number of the one or more first stubs (53-1, 53-2; 53A-1, 53A-2; 53B-1, 53B-2; 53C-1 to 53C-3; 53D-1, 53D-2; 53E-1, 53E-2) and the number of the one or more second stubs (53-3, 53-4; 53A-3, 53A-4; 53B-3, 53B-4; 53C-4 to 53C-6; 53D-3, 53D-4; 53E-3, 53E-4) are equal to each other. This aspect makes it possible to improve electrical symmetry in the antenna substrate (1; 1A to 1F) and contributes to improving antenna characteristics and isolation characteristics between the first radiation electrode (3) and the second radiation electrode (4; 4F).

A fifth aspect is an antenna substrate (1; 1A to 1F) based on the third aspect or the fourth aspect. In this aspect, a first connection position of the one or more first stubs (53-1, 53-2; 53A-1, 53A-2; 53B-1, 53B-2; 53C-1 to 53C-3; 53D-1, 53D-2; 53E-1, 53E-2) with the connection line (52; 52F) and a second connection position of the one or more second stubs (53-3, 53-4; 53A-3, 53A-4; 53B-3, 53B-4; 53C-4 to 53C-6; 53D-3, 53D-4; 53E-3, 53E-4) with the connection line (52; 52F) differ from each other in the second direction (X). This aspect makes it possible to further improve isolation characteristics between the first radiation electrode (3) and the second radiation electrode (4; 4F).

A sixth aspect is an antenna substrate (1; 1A to 1E) based on the fifth aspect. In this aspect, the first connection position and the second connection position are in a point-symmetrical relationship with respect to a center (C5) of the connection line (52) when seen from the first direction (Z). This aspect makes it possible to further improve isolation characteristics between the first radiation electrode (3) and the second radiation electrode (4).

A seventh aspect is an antenna substrate (1; 1B to 1F) based on any one of the first aspect to the sixth aspect. In this aspect, the stub (53; 53B; 53C; 53D; 53E) includes one or more conductive paths (531a, 531b; 531c; 531d; 531e, 531f, 531g) that are formed on the baseplate (2) and one or more chip components (532) that are mounted on the baseplate (2), and the one or more chip components (532) include at least one or more of an inductor, a capacitor, or a 0Ω resistor. This aspect makes it easier to set the resonant frequency of the stub (53; 53B; 53C; 53D; 53E).

An eighth aspect is an antenna substrate (1; 1B to 1F) based on the seventh aspect. In this aspect, at least one of the one or more chip components (532) exists between the one or more conductive paths (531a, 531b; 531c; 531d; 531e, 531f, 531g) and the connection line (52; 52F). This aspect makes it even easier to set the resonant frequency of the stub (53; 53B; 53C; 53D; 53E).

A ninth aspect is an antenna substrate (1; 1A; 1C to 1F) based on any one of the first aspect to the eighth aspect. In this aspect, at least part (531b; 531g) of the stub (53; 53A; 53C; 53D; 53E) extends along the second direction (X). This aspect makes it possible to decrease the electrical length of the stub required to set the resonant frequency of the stub (53; 53B; 53C; 53D; 53E) to a target resonant frequency.

A tenth aspect is an antenna substrate (1; 1A to 1F) based on any one of the first aspect to the ninth aspect. In this aspect, when seen from the first direction (Z), a center (C3) of the first radiation electrode (3) and a center (C5) of the connection line (52; 52F) are disposed side by side along the second direction (X). This aspect makes it possible to further improve isolation characteristics between the first radiation electrode (3) and the second radiation electrode (4; 4F).

An eleventh aspect is an antenna substrate (1; 1A to 1E) based on the tenth aspect. In this aspect, when seen from the first direction (Z), the connection line (52; 52F) has a shape that is line-symmetrical with respect to a line that extends through the center (C3) of the first radiation electrode (3) and that is parallel to the second direction (X). This aspect makes it possible to further improve isolation characteristics between the first radiation electrode (3) and the second radiation electrode (4; 4F).

A twelfth aspect is an antenna substrate (1; 1A to 1F) based on any one of the first aspect to the eleventh aspect. In this aspect, when seen from the first direction (Z), a center (C3) of the first radiation electrode (3) and a feed point (61) of the first radiation electrode (3) are disposed side by side along the second direction (X). This aspect makes it possible to reduce the size of the baseplate (2) in the third direction (Y).

A thirteenth aspect is an antenna substrate (1; 1A to 1F) based on any one of the first aspect to the twelfth aspect. In this aspect, when seen from the first direction (Z), a center (C4) of the second radiation electrode (4; 4F) and a feed point (62; 62F) of the second radiation electrode (4; 4F) are disposed side by side along the second direction (X). This aspect makes it possible to reduce the size of the baseplate (2) in the third direction (Y).

A fourteenth aspect is an antenna substrate (1; 1A to 1F) based on any one of the first aspect to the thirteenth aspect. In this aspect, the ground portion (5; 5A to 5F) includes a plurality of the stubs (53; 53A; 53B; 53C; 53D; 53E), and two or more stubs (53; 53A; 53B; 53D; 53E) of the plurality of the stubs (53; 53A; 53B; 53D; 53E) are connected to the first side (52a) of the connection line (52; 52F) and are disposed side by side along the second direction (X). This aspect makes it possible to further improve isolation characteristics between the first radiation electrode (3) and the second radiation electrode (4; 4F).

A fifteenth aspect is an antenna substrate (1; 1A to 1F) based on the fourteenth aspect. In this aspect, an interval between the two or more stubs (53; 53A; 53B; 53C; 53D; 53E) in the second direction (X) is greater than a width W2 of each of the two or more stubs (53; 53A; 53B; 53C; 53D; 53E). This aspect makes it possible to further improve isolation characteristics between the first radiation electrode (3) and the second radiation electrode (4; 4F).

A sixteenth aspect is an antenna substrate (1C) based on the fourteenth aspect or the fifteenth aspect. In this aspect, two or more of the two or more stubs (53C) have electrical lengths that differ from each other. This aspect makes it possible to, in a wider frequency band, improve isolation characteristics between the first radiation electrode (3) and the second radiation electrode (4, 4F).

A seventeenth aspect is an antenna substrate (1E) based on any one of the first aspect to the sixteenth aspect. In this aspect, at least part (531f) of the stub (53E) extends along a direction that intersects a plane including the second direction (X) and the third direction (Y). This aspect makes it possible to reduce the size of the baseplate (2) in the third direction (Y).

An eighteenth aspect is an antenna substrate (1D) based on any one of the first aspect to the seventeenth aspect. In this aspect, the stub (53D) has a shape that is bent two or more times. This aspect makes it possible to decrease a maximum value of a length of a side of a region required to dispose the stub (53D).

A nineteenth aspect is an antenna substrate (1; 1A to 1E) based on any one of the first aspect to the eighteenth aspect. In this aspect, the second radiation electrode (4) has a planar shape, the ground electrode (51) is a first ground electrode (51), the ground portion (5; 5A to 5E) includes a second ground electrode (54) that faces the second radiation electrode (4) when seen from the first direction (Z), and the connection line (52) connects the first ground electrode (51) and the second ground electrode (54) to each other. This aspect makes it possible to improve electrical symmetry in the antenna substrate (1; 1A to 1E) and contributes to improving antenna characteristics and isolation characteristics between the first radiation electrode (3) and the second radiation electrode (4).

A twentieth aspect is an antenna substrate (1F) based on any one of the first aspect to the eighteenth aspect. In this aspect, the second radiation electrode (4F) exists on a side opposite to the first radiation electrode (3) with respect to the connection line (52F) so as not to face the ground portion (5F) when seen from the first direction (Z). This aspect makes it possible to reduce the size of the baseplate (2).

A twenty-first aspect is an antenna substrate (1; 1A to 1F) based on any one of the first aspect to the twentieth aspect. In this aspect, the second direction (X) is a length direction of the baseplate (2) and the third direction (Y) is a width direction of the baseplate (2). This aspect makes it possible to reduce the size of the baseplate (2).

A twenty-second aspect is an antenna substrate (1E) based on any one of the first aspect to the twenty-first aspect. In this aspect, in the third direction (Y), the stub (53E) fits between a side (52a, 52b) of the connection line (52) to which the stub (53E) is connected and a side (3a, 3b) of the first radiation electrode (3) that exists on a same side as the side (52a, 52b) of the connection line (52) to which the stub (53E) is connected. This aspect makes it possible to reduce the size of the baseplate (2) in the third direction (Y).

A twenty-third aspect includes the antenna substrate (1; 1A to 1F) based on any one of the first aspect to the twenty-second aspect, and an electronic component (11, 12) that is mounted on the antenna substrate (1; 1A to 1F). This aspect makes it possible to improve isolation characteristics between the first radiation electrode (3) and the second radiation electrode (4; 4F).

The second aspect to the twenty-second aspect are optional and are not essential.

### INDUSTRIAL APPLICABILITY

The disclosure is applicable to an antenna substrate and an antenna module including the antenna substrate. Specifically, the disclosure is applicable to an antenna substrate including a plurality of radiation electrodes and to an antenna module including the antenna substrate.

### REFERENCE SIGNS LIST

10 antenna module
11, 12 electronic component
1, 1A, 1B, 1C, 1D, 1E, 1F antenna substrate
2 baseplate
3 first radiation electrode
3a first side (side of first radiation electrode)
3b second side (side of first radiation electrode)
4, 4F second radiation electrode
5, 5A, 5B, 5C, 5D, 5E, 5F ground portion
51 ground electrode (first ground electrode)
52, 52F connection line
52a first side (side of ground electrode)
52b second side (side of ground electrode)
53-1, 53-2 stub (first stub)
53-3, 53-4 stub (second stub)
53A-1, 53A-2 stub (first stub)
53A-3, 53A-4 stub (second stub)
53B-1, 53B-2 stub (first stub)
53B-3, 53B-4 stub (second stub)
53C-1, 53C-2, 53C-3 stub (first stub)
53C-4, 53C-5, 53C-6 stub (second stub)
53D-1, 53D-2 stub (first stub)
53D-3, 53D-4 stub (second stub)
53E-1, 53E-2 stub (first stub)
53E-3, 53E-4 stub (second stub)
53F-1, 53F-2 stub (first stub)
53F-3, 53F-4 stub (second stub)
531a, 531b, 531c, 531d, 531e, 531f, 531g conductive path
532 chip component
54 second ground electrode
61 feed point
62, 62F feed point
C3 center (center of first radiation electrode)
C4 center (center of second radiation electrode)
C5 center (center of connection line)
Z first direction
X second direction
Y third direction

1. An antenna substrate comprising:
a baseplate;
a first radiation electrode that is disposed on the baseplate and that has a planar shape;
a second radiation electrode that is disposed on the baseplate and spatially apart from the first radiation electrode in a second direction when seen from a first direction along a thickness direction of the baseplate; and
a ground portion that is disposed on the baseplate and that is common to the first radiation electrode and the second radiation electrode,
wherein the ground portion includes
a ground electrode that faces the first radiation electrode when seen from the first direction,
a connection line between the first radiation electrode and the second radiation electrode when seen from the first direction and that has a size that is smaller than a size of the ground electrode in a third direction orthogonal to the second direction when seen from the first direction, and
a stub that is connected to one of a first side and a second side of the connection line that face each other in the third direction.

2. The antenna substrate according to claim 1,
wherein the size of the connection line is smaller than a size of the first radiation electrode in the third direction.

3. The antenna substrate according to claim 1,
wherein the ground portion includes a plurality of the stubs, the plurality of the stubs include
one or more first stubs that are connected to the first side of the connection line, and
one or more second stubs that are connected to the second side of the connection line, the one or more first stubs being different than the one or more second stubs.

4. The antenna substrate according to claim 3,
wherein a total number of the one or more first stubs is equal to a total number of the one or more second stubs.

5. The antenna substrate according to claim 3,
wherein a first connection position of the one or more first stubs with the connection line and a second connection position of the one or more second stubs with the connection line differ from each other in the second direction.

6. The antenna substrate according to claim 5,
wherein the first connection position and the second connection position are in a point-symmetrical relationship with respect to a center of the connection line when seen from the first direction.

7. The antenna substrate according to claim 1,
wherein the stub includes
one or more conductive paths on the baseplate, and
one or more chip components that are mounted on the baseplate, and
wherein the one or more chip components include at least one of an inductor, a capacitor, or a 0Ω resistor.

8. The antenna substrate according to claim 7,
wherein at least one of the one or more chip components exists between the one or more conductive paths and the connection line.

9. The antenna substrate according to claim 1,
wherein at least part of the stub extends along the second direction.

10. The antenna substrate according to claim 1,
wherein when seen from the first direction, a center of the first radiation electrode and a center of the connection line are disposed side by side along the second direction.

11. The antenna substrate according to claim 1,
wherein when seen from the first direction, a center of the first radiation electrode and a feed point of the first radiation electrode are disposed side by side along the second direction.

12. The antenna substrate according to claim 1,
wherein when seen from the first direction, a center of the second radiation electrode and a feed point of the second radiation electrode are disposed side by side along the second direction.

13. The antenna substrate according to claim 1,
wherein the ground portion includes a plurality of stubs including the stub and at least another stub, and
wherein two or more stubs of the plurality of stubs are connected to the first side of the connection line and are disposed side by side along the second direction.

14. The antenna substrate according to claim 13,
wherein an interval between the two or more stubs of the plurality of stubs in the second direction is greater than a width of each of the two or more stubs of the plurality of stubs.

15. The antenna substrate according to claim 13,
wherein two or more of the two or more stubs of the plurality of stubs have electrical lengths that differ from each other.

16. The antenna substrate according to claim 1,
wherein at least part of the stub extends along a direction that intersects a plane including the second direction and the third direction.

17. The antenna substrate according to claim 1,
wherein the second radiation electrode has a planar shape,
wherein the ground electrode is a first ground electrode,
wherein the ground portion includes a second ground electrode that faces the second radiation electrode when seen from the first direction, and
wherein the connection line connects the first ground electrode and the second ground electrode to each other.

18. The antenna substrate according to claim 1,
wherein the second radiation electrode is positioned on a side opposite to the first radiation electrode with respect to the connection line so as not to face the ground portion when seen from the first direction.

19. The antenna substrate according to claim 1,
wherein in the third direction, the stub fits between a side of the connection line to which the stub is connected and a side of the first radiation electrode that exists on a same side as the side of the connection line to which the stub is connected.

20. An antenna module comprising:
an antenna substrate; and
an electronic component that is mounted on the antenna substrate, the antenna substrate including
a baseplate,
a first radiation electrode that is disposed on the baseplate and that has a planar shape,
a second radiation electrode that is disposed on the baseplate and spatially apart from the first radiation electrode in a second direction when seen from a first direction along a thickness direction of the baseplate, and
a ground portion that is disposed on the baseplate and that is common to the first radiation electrode and the second radiation electrode,
wherein the ground portion includes
a ground electrode that faces the first radiation electrode when seen from the first direction,
a connection line between the first radiation electrode and the second radiation electrode when seen from the first direction and that has a size that is smaller than a size of the ground electrode in a third direction orthogonal to the second direction when seen from the first direction, and
a stub that is connected to one of a first side and a second side of the connection line that face each other in the third direction.
